(19) United States
(12) Patent Application Publication
(10) Pub. No.: US 2025/0362850 A1
(43) Pub. Date: Nov. 27, 2025

(54) IMAGE PROCESSING APPARATUS, METHOD, AND NON-TRANSITORY COMPUTER-READABLE STORAGE MEDIUM

(71) Applicant: CANON KABUSHIKI KAISHA, Tokyo (JP)

(72) Inventor: TAKAFUMI MIZUNO, Tokyo (JP)

(21) Appl. No.: 19/208,412

(22) Filed: May 14, 2025

(30) Foreign Application Priority Data
May 23, 2024 (JP) 2024-084011

(51) Int. Cl. G06F 3/12

(52) U.S. Cl. CPC G06F 3/1258; G06F 3/1205

(57) ABSTRACT

An image processing apparatus including a scanner includes a control unit, and a connection unit, wherein, according to a communication connection established, in response to a connection request from an information processing apparatus which lies close to the image processing apparatus, by the connection unit with the information processing apparatus, the control unit performs displaying, on an operation unit of the image processing apparatus, of a first icon operable to perform print processing for printing, by the image processing apparatus, print data received from the information processing apparatus and a second icon operable to perform scan processing for transmitting, to the information processing apparatus, scan data obtained by the scanner reading an original, and wherein, in a case where print processing using the first icon has been performed, the control unit performs deletion of the first icon and the second icon.

### BACKGROUND

### Field of the Disclosure

Aspects of the present disclosure generally relate to a technique for the use of an image processing apparatus including a scanner.

### Description of the Related Art

Conventionally, in the case of using a multifunction peripheral (MFP), the user using a specific MFP located near the user's own desk in the user's own office has been a main use case.

Recently, with an increase in distributed work, places to work have become diversified from the user's own office to, for example, coworking spaces or shared offices. Moreover, even in an office, mobile terminals such as notebook personal computers (PCs) or tablet terminals have been being actively used and hot-desking (open plan office) has been in widespread use, so that office operations have been changing from those using assigned desks.

Under such circumstances, there are increasing opportunities to use not an MFP located near the user's own desk as in a conventional usage but an MFP which the user will use for the first time. There is an MFP which allows a nearby client terminal to easily connect thereto and displays an icon operable to perform printing or scanning on the MFP, thus enabling performing printing or scanning. Such an icon needs to be deleted if the icon has become unnecessary.

Japanese Patent Application Laid-Open No. 2018-32250 discusses a technique which sets a deletion grace period until deleting an icon displayed in a screen of, for example, an image processing apparatus from the screen, based on information which the user has sets with respect to the icon (for example, an icon name) and deletes an icon which has become out of use beyond the deletion grace period from the screen.

The discussed technique is a technique which varies a period until deleting an icon from the screen based on information which the user has set to the icon, and presupposes the use of an apparatus which a specific user uses on a daily basis and enables the user to easily find out a target icon in such an apparatus.

Therefore, even if the discussed technique is applied to an image processing apparatus which is used by many and unspecified users in a shared manner, such as an MFP installed in, for example, a coworking space or shared office, it is not always possible to delete an icon at appropriate timing.

For example, there is a case where the user uses an MFP by connecting the user's own mobile terminal to an MFP and causing an icon operable to perform printing or scanning to be displayed in the MFP. In such a case, if the icon which the user has finished using remains displayed in the MFP, there is a possibility that the mobile terminal, which is currently connected to the MFP, is used, without the user's permission, by another user performing an icon operation.

To prevent the occurrence of such situation, it is necessary to delete an icon which is being displayed in the MFP at timing when the user has finished using the MFP. Furthermore, since usage timing differs depending on functions associated with the icon, if the icon is deleted without exception, on the contrary, usability may become worse.

### SUMMARY

According to an aspect of the present disclosure, an image processing apparatus including a scanner includes a control unit, and a connection unit, wherein, according to a communication connection established, in response to a connection request from an information processing apparatus which lies close to the image processing apparatus, by the connection unit with the information processing apparatus, the control unit performs displaying, on an operation unit of the image processing apparatus, of a first icon operable to perform print processing for printing, by the image processing apparatus, print data received from the information processing apparatus and a second icon operable to perform scan processing for transmitting, to the information processing apparatus, scan data obtained by the scanner reading an original, and wherein, in a case where print processing using the first icon has been performed, the control unit performs deletion of the first icon and the second icon.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system according to one or more aspects of the present disclosure.

FIG. 2 is a diagram illustrating an example of particulars of a controller unit included in a multifunction peripheral (MFP).

FIG. 3 is a block diagram illustrating an example of particulars of a client terminal.

FIG. 4 is a block diagram illustrating an example of a software configuration of the MFP.

FIG. 5 is a block diagram illustrating an example of a software configuration of the client terminal.

FIGS. 6A, 6B, 6C, 6D, and 6E are diagrams illustrating examples of sequences which are performed according to one or more aspects of the present disclosure.

FIGS. 7A, 7B, and 7C are diagrams illustrating examples of screens each of which is displayed in the client terminal according one or more aspects of the present disclosure.

FIGS. 8A and 8B are diagrams illustrating examples of screens each of which is displayed in the MFP according to one or more aspects of the present disclosure.

FIGS. 9A and 9B are diagrams illustrating an example of a screen transition for easy print in the MFP according to one or more aspects of the present disclosure.

FIGS. 10A, 10B, 10C, 10D, and 10E are diagrams illustrating an example of a screen transition for easy scan in the MFP according to one or more aspects of the present disclosure.

FIGS. 11A and 11B are diagrams illustrating an example of a screen transition occurring in a case where easy print has been cancelled in the MFP according to one or more aspects of the present disclosure.

FIG. 12 is a diagram illustrating an example of an auto-clear time setting screen in the MFP according to one or more aspects of the present disclosure.

FIG. 13 is a flowchart illustrating an example of processing which the MFP performs according to one or more aspects of the present disclosure.

FIGS. 14A and 14B are diagrams illustrating examples of setting screens each of which is displayed in the MFP according to one or more aspects of the present disclosure.

FIG. 15 is a flowchart illustrating an example of processing which the MFP performs according to one or more aspects of the present disclosure.

FIG. 16 is a diagram illustrating an example of a sequence which is performed according to one or more aspects of the present disclosure.

FIGS. 17A and 17B are diagrams illustrating examples of screens each of which is displayed in the client terminal according to one or more aspects of the present disclosure.

FIGS. 18A and 18B are flowcharts illustrating an example of processing which the MFP performs according to one or more aspects of the present disclosure.

FIGS. 19A and 19B are diagrams illustrating examples of screens each of which is displayed in the MFP according to one or more aspects of the present disclosure.

FIG. 20 is a flowchart illustrating an example of processing which the MFP performs according to one or more aspects of the present disclosure.

### DESCRIPTION OF THE EMBODIMENTS

Various exemplary embodiments, features, and aspects of the disclosure will be described in detail below with reference to the drawings. However, not all of the features described in the following exemplary embodiments are necessarily essential for solutions in the present disclosure. The following exemplary embodiments are described with respect to an example in which an image processing apparatus and a client terminal cooperate with each other.

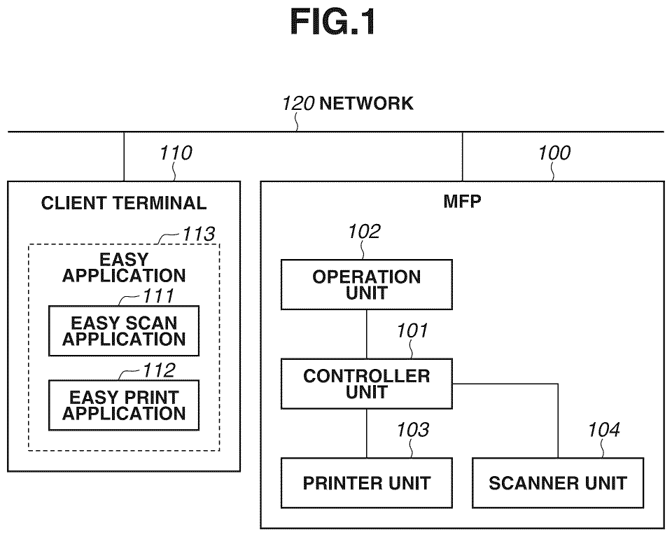

FIG. 1 is a diagram illustrating an example of a system according to a first exemplary embodiment of the present disclosure.

The system in the first exemplary embodiment includes a multifunction peripheral (MFP) 100 and a client terminal 110. The MFP 100 and the client terminal 110 are connected via a network 120 in such a way as to be able to communicate with each other. In the first exemplary embodiment, the network 120 is a wireless connection.

The MFP 100 is an image processing apparatus such as a multifunction peripheral. The MFP 100 has the functions of scanning an image to be read, printing an image with a printer, and performing transmission and reception of facsimile (FAX). The MFP 100 includes an operation unit 102 which takes charge of inputting from and outputting to the user. The MFP 100 includes a printer unit 103 which outputs electronic data to a paper medium. The MFP 100 includes a scanner unit 104 which converts an image of a paper medium into electronic data. The operation unit 102, the printer unit 103, and the scanner unit 104 are connected to a controller unit 101, and implement the function as a multifunction peripheral under the control of the controller unit 101.

The client terminal 110 is an information processing apparatus configured to include, for example, application programs (hereinafter referred to as “applications”), such as an easy application 113, an operating system (hereinafter referred to as an “OS”), and various types of drivers such as a printer driver. Furthermore, the easy application 113 includes an easy scan application 111 and an easy print application 112. In the following description, the easy scan application 111 and the easy print application 112 are collectively referred to as the “easy application 113” when being collectively explained. The client terminal 110 can be configured to include, in addition to the easy scan application 111 and the easy print application 112, various applications such as a document creation application and a spread sheet application (not illustrated).

The easy scan application 111 is an application which performs connection to the MFP 100 and which launches a file server included in the easy scan application 111 and receives, via the file server, electronic data obtained by the MFP 100 performing scanning. The easy print application 112 is an application which transmits, to the connected MFP 100, print data generated in an application (not illustrated) such as a document creation application or a spread sheet application installed on the client terminal 110 with use of a printer driver (not illustrated) and causes the MFP 100 to perform printing.

Examples of the client terminal 110 include a notebook personal computer (PC), a tablet terminal, and a smartphone. Furthermore, while, with reference to FIG. 1, only a configuration usable for describing the first exemplary embodiment is described, the configuration can include elements other than those illustrated in FIG. 1 as long as the first exemplary embodiment is able to be implemented, and, naturally, the connection configuration between the respective constituent elements is not limited to the one illustrated in FIG. 1.

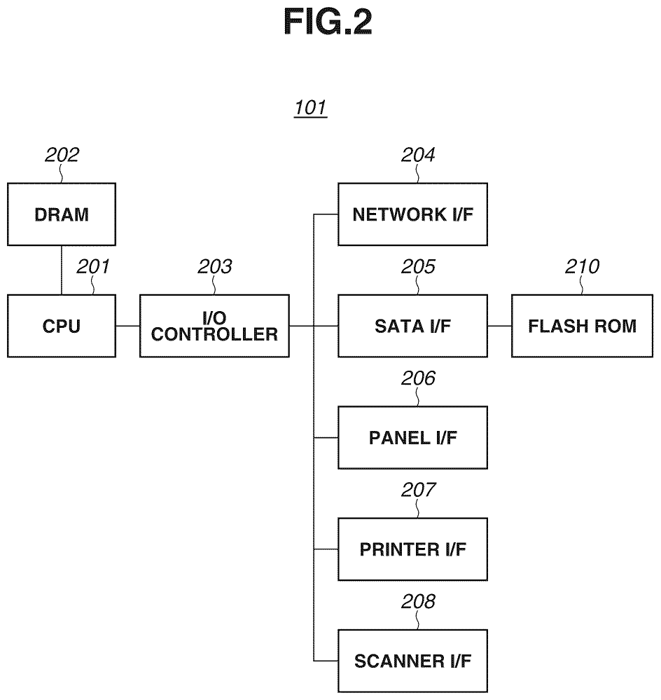

FIG. 2 is a block diagram illustrating an example of particulars of the controller unit 101 of the MFP 100.

A central processing unit (CPU) 201 performs main arithmetic processing in the controller unit 101. The CPU 201 is connected to a dynamic random access memory (DRAM) 202 via a bus. The DRAM 202 is used by the CPU 201 as a work memory for temporarily allocating program data representing an arithmetic operation command during the process in which the CPU 201 performs arithmetic operation and data which is targeted for processing.

Moreover, the CPU 201 is connected to an input-output (I/O) controller 203 via a bus. The I/O controller 203 performs inputting and outputting to and from various devices under the control of the CPU 201.

To the I/O controller 203, a Serial Advanced Technology Attachment (SATA) interface (I/F) 205 is connected, and, to the SATA I/F 205, a flash read-only memory (ROM) 210 is connected. The CPU 201 uses the flash ROM 210 to permanently store a program for implementing the function of the MFP 100 and a document file. Not a flash ROM but another type of storage device such as a hard disk drive (HDD) can be connected or these can be used in combination.

Moreover, to the I/O controller 203, a network I/F 204 is also connected. To the network I/F 204, a wired local area network (LAN) device or a wireless LAN device is connected. The CPU 201 controls the wired LAN device or wireless LAN device via the network I/F 204, thus implementing communications on the network 120.

Moreover, to the I/O controller 203, a panel I/F 206 is connected. The CPU 201 implements inputting and outputting for the user to and from the operation unit 102 via the panel I/F 206.

Moreover, to the I/O controller 203, a printer I/F 207 is connected. The CPU 201 implements output processing for a paper medium using the printer unit 103 via the printer I/F 207.

Moreover, to the I/O controller 203, a scanner I/F 208 is connected. The CPU 201 implements reading of an image from an original using the scanner unit 104 via the scanner I/F 208.

The MFP 100 is configured to include various applications for using the functions of the MFP 100. Examples of the applications include applications corresponding to a copy function, a transmission function, a facsimile function, and a box function. The CPU 201 implements these functions by reading program data corresponding to each of the respective functions from the flash ROM 210 via the SATA I/F 205 onto the DRAM 202 and executing the program data.

In the case of executing the copy function, the CPU 201 detects a copy instruction from the user with respect to the operation unit 102 via the panel I/F 206, according to a program read onto the DRAM 202. Upon detecting the copy instruction, the CPU 201 receives an image of an original as electronic data from the scanner unit 104 via the scanner I/F 208, and then stores the electronic data in the DRAM 202. The CPU 201 performs, for example, color conversion processing adapted for outputting on image data stored in the DRAM 202. The CPU 201 transfers image data stored in the DRAM 202 to the printer unit 103 via the printer I/F 207, thus performing output processing to a paper medium.

Processing which the CPU 201 performs to detect a transmission instruction from the user in the case of executing the transmission function is the same as that in the case of executing the above-mentioned copy function. The transmission instruction includes, for example, a transmission protocol from the user, a transmission destination designation, and an image format. The transmission protocol is, for example, Server Message Block (SMB) or File Transfer Protocol (FTP), and the transmission destination designation is, for example, a designation using Universal Naming Convention (UNC). The image format is, for example, Joint Photographic Experts Group (JPEG) or Portable Document Format (PDF). Upon detecting the transmission instruction, the CPU 201 receives an image of an original as electronic data from the scanner unit 104 via the scanner I/F 208, and then stores the electronic data in the DRAM 202. The CPU 201 performs, for example, image format conversion designated by the user on image data stored in the DRAM 202. The CPU 201 performs transfer of image data stored in the DRAM 202 to a transmission destination via the network I/F 204 with a protocol designated by the user.

Processing which the CPU 201 performs to detect a facsimile instruction from the user in the case of executing the facsimile function is the same as that in the case of executing the above-mentioned copy function. Upon detecting the facsimile instruction, the CPU 201 receives an image of an original as electronic data from the scanner unit 104 via the scanner I/F 208, and then stores the electronic data in the DRAM 202. The CPU 201 performs, for example, image format conversion for facsimile on image data stored in the DRAM 202. The CPU 201 performs transfer of image data stored in the DRAM 202 to, for example, a facsimile telephone number designated by the facsimile instruction, via, for example, a telephone network (not illustrated) to which a facsimile I/F (not illustrated) is connected. Facsimile using a telephone line is merely an example, and Internet facsimile can also be used.

The box function is a function of storing a scanned image in a storage region inside the MFP 100 or in a memory medium connected to the MFP 100 or, with the MFP 100 serving as a file server, releasing an image stored in the MFP 100 to an external PC or another MFP (each not illustrated). Processing which the CPU 201 performs to detect a box storage instruction from the user in the case of executing the box function is the same as that in the case of executing the above-mentioned copy function. The box storage instruction includes, for example, a storage destination designation from the user and an image format. The storage destination is a path of a storage inside the MFP 100 or a memory medium connected to the MFP 100. The image format is, for example, JPEG or PDF. Upon detecting the box storage instruction, the CPU 201 receives an image of an original as electronic data from the scanner unit 104 via the scanner I/F 208, and then stores the electronic data in the DRAM 202. The CPU 201 performs, for example, image format conversion designated by the user on image data stored in the DRAM 202. The CPU 201 performs transfer of image data stored in the DRAM 202 to a storage destination designated by the user, such as the flash ROM 210 inside the MFP 100 or a memory medium (not illustrated), via the SATA I/F 205.

Furthermore, the facsimile function can also include not printing a received image but converting the received image into a format available for viewing by, for example, a PC and storing the converted image into a box. Moreover, the box function can include, with the MFP 100 serving as a file server such as an SMB server, releasing the content of the flash ROM 210. In the box function, the CPU 201 detects a box access instruction received from an external unit via the network I/F 204. The box access instruction includes, for example, an image file path of the access destination. The CPU 201 performs transfer of image data stored in the flash ROM 210 corresponding to the designated image file path to a request source (requester) of the box access instruction via the network I/F 204.

Furthermore, the above-described functions are merely examples of functions of the MFP 100 and can additionally include functions other than the above-described functions.

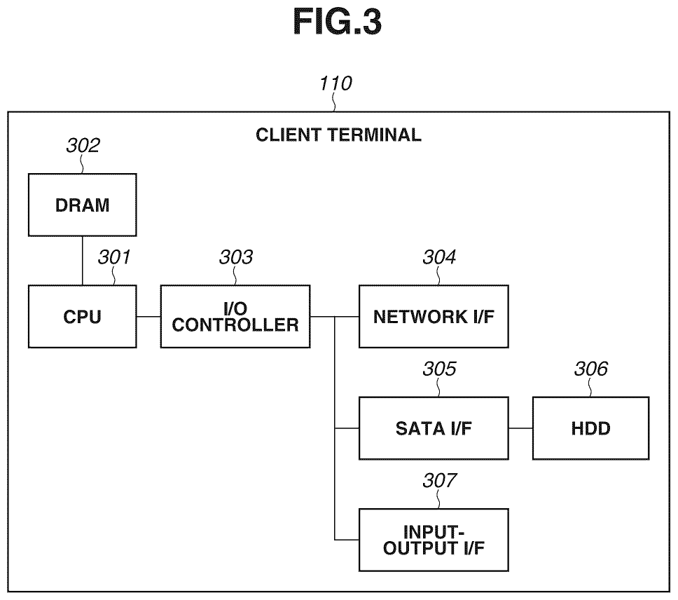

FIG. 3 is a block diagram illustrating an example of particulars of the client terminal 110.

A CPU 301 is connected to a DRAM 302 via a bus. The DRAM 302 is used by the CPU 301 as a work memory for temporarily allocating program data representing an arithmetic operation command during the process in which the CPU 301 performs arithmetic operation and data which is targeted for processing.

The CPU 301 is connected to an I/O controller 303 via a bus.

To the I/O controller 303, a network I/F 304 is connected. To the network I/F 304, a wired LAN device or a wireless LAN device, or a data communication device, is connected. The CPU 301 controls the wired LAN device, the wireless LAN device, or the data communication device via the network I/F 304, thus implementing communications on the network 120.

Moreover, the I/O controller 303 performs inputting and outputting to and from various devices under the control of the CPU 301.

To the I/O controller 303, a Serial Advanced Technology Attachment (SATA) I/F 305 is connected, and, to the SATA I/F 305, an HDD 306 is connected. Not an HDD but another type of storage device such as a solid state drive (SSD) or an embedded MultiMediaCard (eMMC) can be connected or these can be used in combination. The CPU 301 uses the HDD 306 to permanently store setting values for, for example, programs such as the easy scan application 111 and the easy print application 112.

Moreover, to the I/O controller 303, an input-output I/F 307 is connected, and the CPU 301 implements inputting and outputting for the user to and from an input-output device of the client terminal 110 connected via the input-output I/F 307. Examples of the input-output device include a touch panel serving as both input and output units being connected to the input-output I/F 307 and a set including an output device such as a display for performing displaying and an input device such as a keyboard for performing inputting, each of the output device and the input device being connected to the input-output I/F 307.

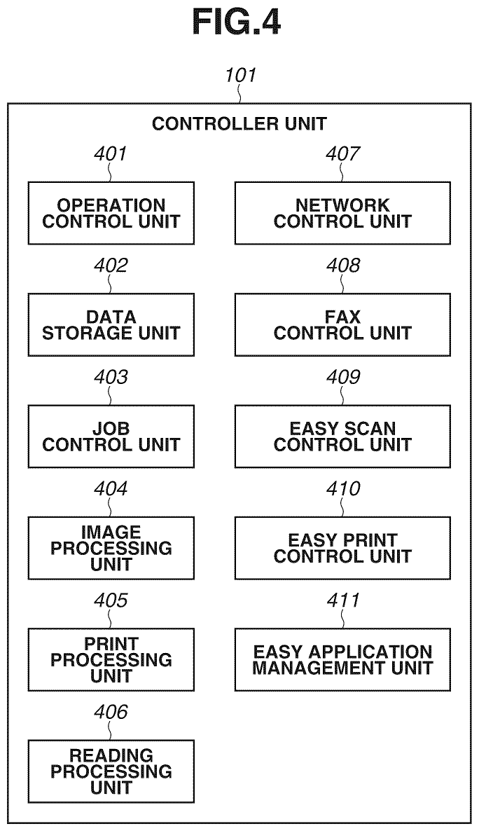

FIG. 4 is a block diagram illustrating an example of a configuration of software which is executed by the controller unit 101 of the MFP 100. The software which is executed by the controller unit 101 is executed after the CPU 201 reads out a program stored in the flash ROM 210 onto the DRAM 202, and thus implements functional units such as units 401 to 411 illustrated in FIG. 4.

An operation control unit 401 performs processing for displaying a screen image directed to the user on the operation unit 102 and processing associated with detection of a user operation performed via the operation unit 102 and screen components such as buttons displayed in the screen.

A data storage unit 402 performs storing and reading-out of a request from another control unit in and from the flash ROM 210.

A job control unit 403 controls execution of a job according to an instruction from another control unit.

An image processing unit 404 processes image data into a form adapted for each use application according to an instruction from the job control unit 403.

A print processing unit 405 prints and outputs an image on a paper medium via the printer I/F 207 according to an instruction from the job control unit 403.

A reading processing unit 406 scans a set original via the scanner I/F 208 according to an instruction from the job control unit 403.

A network control unit 407 performs inputting and outputting of data to and from a LAN, Wi-Fi®, or a public line network via the network I/F 204 according to an instruction from each control unit. Moreover, the network control unit 407 makes data stored in the flash ROM 210 by the data storage unit 402 via the SATA I/F 205 accessible from an external device. Examples of data to be stored in the flash ROM 210 include an image of, for example, PDF or JPEG format.

A facsimile (FAX) control unit 408 performs reception processing on FAX data received from the network control unit 407 according to an instruction from the job control unit 403, and instructs the print processing unit 405 to perform printing or converts FAX data into an image of, for example, PDF or JPEG format and stores the obtained image in the data storage unit 402. Moreover, the FAX control unit 408 performs transmission of FAX data via the network control unit 407 based on image data obtained by scanning performed by the reading processing unit 406.

An easy scan control unit 409 performs processing concerning scanning with the client terminal 110. The easy scan control unit 409 is a control unit for implementing the processing to be performed on the side of the MFP 100 to implement the function of the easy scan application 111 described above with reference to FIG. 1. The easy scan control unit 409 uses the network control unit 407 to perform communication processing with the client terminal 110. Moreover, the easy scan control unit 409 uses the operation control unit 401 to perform displaying of a scan execution screen or an error screen. Moreover, the easy scan control unit 409 issues a scan instruction to the job control unit 403, performs scanning with use of the reading processing unit 406, and transmits scan data stored in the data storage unit 402 to the client terminal 110 with use of the network control unit 407.

An easy print control unit 410 performs processing concerning printing with the client terminal 110. The easy print control unit 410 is a control unit for implementing the processing to be performed on the side of the MFP 100 to implement the function of the easy print application 112 described above with reference to FIG. 1. The easy print control unit 410 uses the network control unit 407 to perform communication processing with the client terminal 110. Moreover, the easy print control unit 410 uses the operation control unit 401 to display a print execution screen or an error screen and issue a print instruction to the job control unit 403, thus performing printing of print data transmitted from the client terminal 110 and then stored in the data storage unit 402 with use of the print processing unit 405. Furthermore, in the description of the first exemplary embodiment, an example in which, without immediately printing print data received from the client terminal 110, the MFP 100 temporarily stores the print data in the data storage unit 402 and then performs printing of the print data in response to the user issuing a print instruction via a print execution screen which is displayed on the operation unit 102 by the easy print control unit 410 is described. This is because of preventing a printed sheet from being left unattended in the MFP 100.

An easy application management unit 411 performs processing which is performed at the time of connection to and at the time of disconnection from the easy application 113 included in the client terminal 110. When being connected from the easy application 113 of the client terminal 110 via the network control unit 407, the easy application management unit 411 requests the easy scan control unit 409 or the easy print control unit 410 to control scanning or printing. Moreover, the easy application management unit 411 instructs the operation control unit 401 to perform display processing or deletion processing of a button for executing easy print or easy scan in a menu screen of the MFP 100, as described below. When a disconnection instruction has been received from the easy application 113 of the client terminal 110 or when the MFP 100 itself performs disconnection, the easy application management unit 411 performs processing for disconnection from the client terminal 110 with use of the network control unit 407.

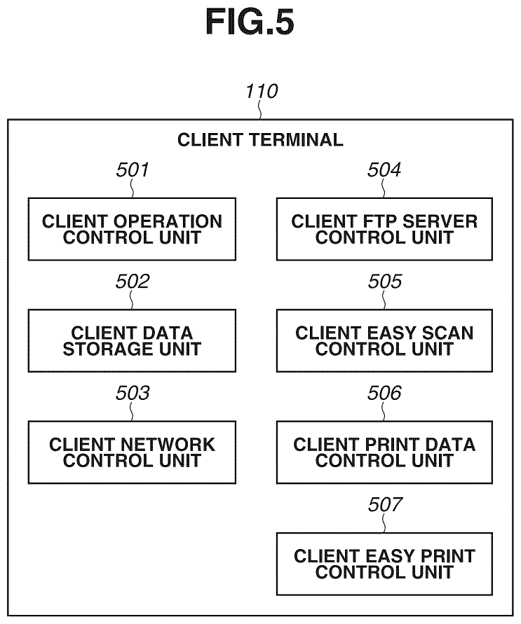

FIG. 5 is a block diagram illustrating an example of a software configuration of the client terminal 110.

Software including the easy application 113 (including the easy scan application 111 and the easy print application 112) which is executed by the client terminal 110 is executed after the CPU 301 reads out a program stored in the HDD 306 onto the DRAM 302, and thus implements functional units such as units 501 to 507 illustrated in FIG. 5.

A client operation control unit 501 performs processing for displaying a screen image directed to the user and processing associated with detection of a user operation and screen components such as buttons displayed in the screen.

A client data storage unit 502 performs storing and reading-out of electronic data such as an image file in and from the HDD 306.

A client network control unit 503 performs network communication with an external apparatus.

A client FTP server control unit 504 executes an FTP server function inside the client terminal 110 and performs exchange of data with the MFP 100 with use of the client network control unit 503.

A client easy scan control unit 505 uses the above-mentioned units 501 to 504 to provide an easy scan function (the function of the easy scan application 111) to the user of the client terminal 110.

A client print data control unit 506 uses, for example, a printer driver included in the applications (not illustrated) usable by the client terminal 110 to perform generation of print data which is able to be printed by the MFP 100. Upon the generation of print data, the client print data control unit 506 transmits the print data to the MFP 100 with use of the client network control unit 503.

Furthermore, the generation of print data by the printer driver and the transmission of print data to the MFP 100 are known techniques and are, therefore, omitted from description.

A client easy print control unit 507 uses the above-mentioned units 501 to 503 and 506 to provide an easy print function (the function of the easy print application 112) to the user of the client terminal 110.

Furthermore, while the client terminal 110 operates according to an OS and, on the OS, applications such as the easy application 113 run, since the OS is not the gist of the first exemplary embodiment, operations of the OS are omitted from description.

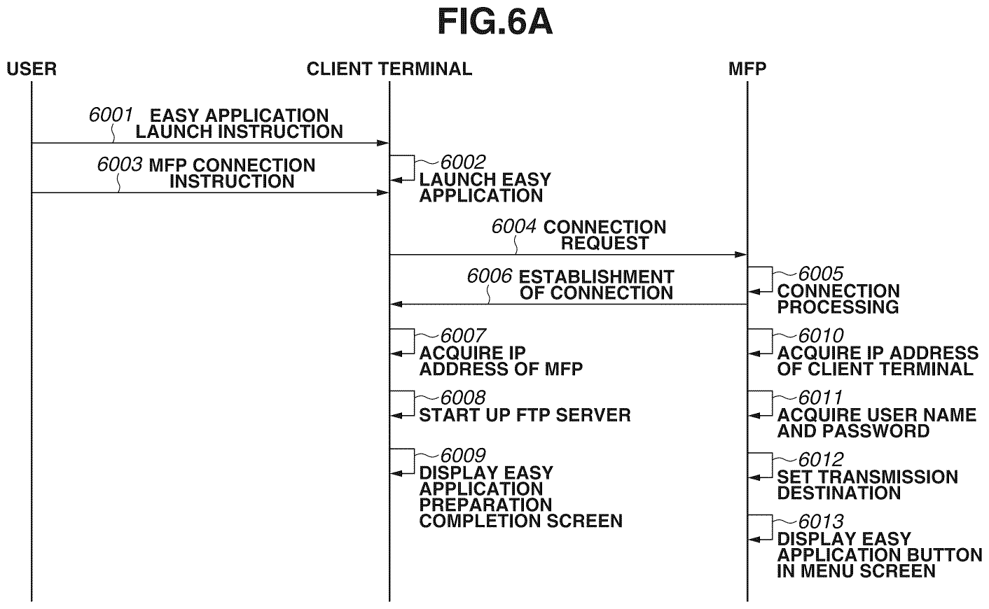

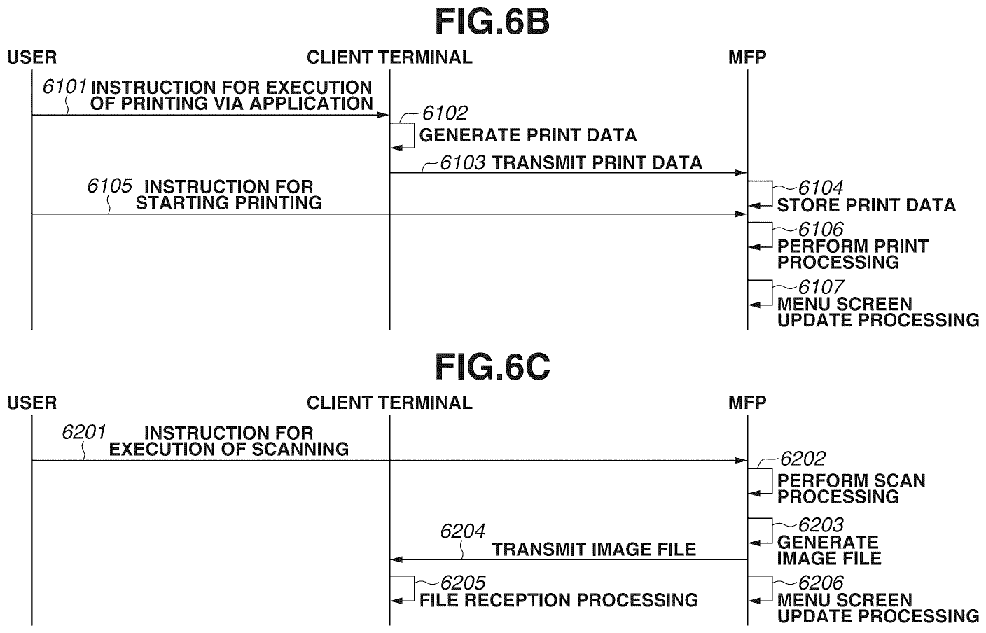

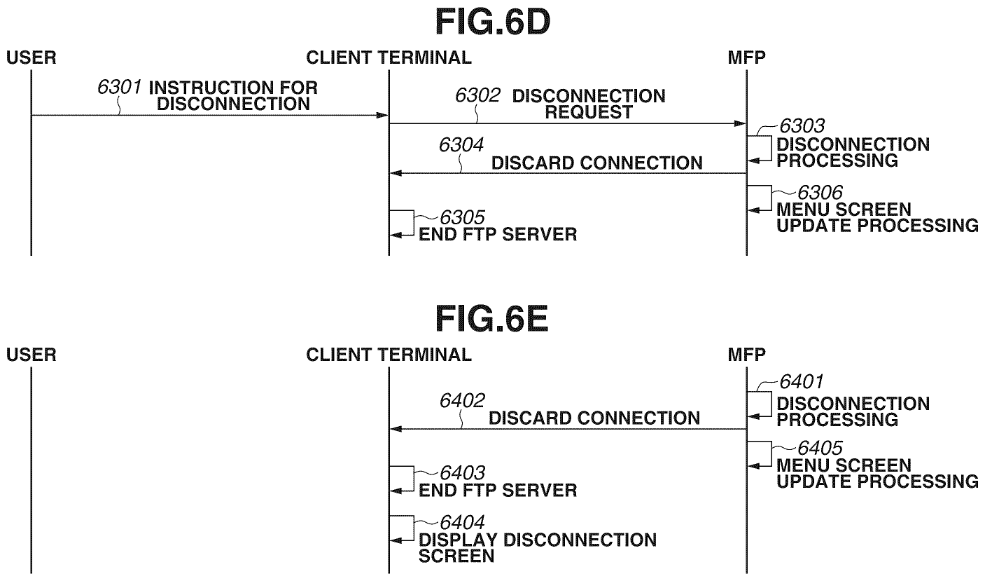

In the following description, the outline of an operation of the system in the first exemplary embodiment is described with reference to FIGS. 6A, 6B, 6C, 6D, and 6E to FIG. 12.

FIGS. 6A to 6E are diagrams illustrating examples of sequences in the client terminal 110 and the MFP 100 which are performed when the client terminal 110 executes the easy application 113 in the first exemplary embodiment.

Furthermore, processing illustrated in FIGS. 6A to 6E which is performed in the client terminal 110 is performed by a function implemented by the CPU 301 reading out a program stored in the HDD 306 onto the DRAM 302 and executing the program. Moreover, processing illustrated in illustrated in FIGS. 6A to 6E which is performed in the MFP 100 is performed by a function implemented by the CPU 201 reading out a program stored in the flash ROM 210 onto the DRAM 202 and executing the program.

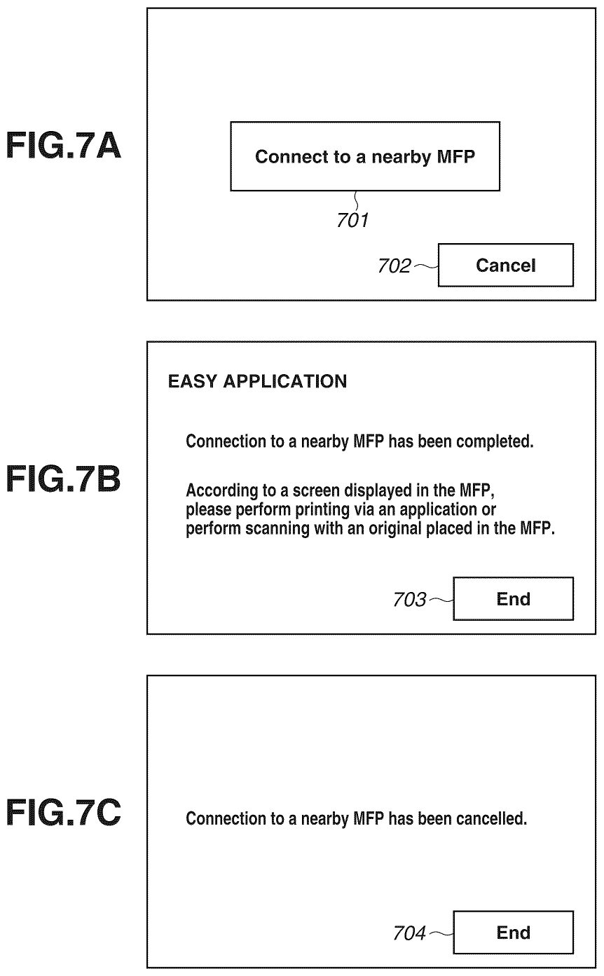

FIGS. 7A, 7B, and 7C are diagrams illustrating examples of screens each of which is displayed on the output device of the client terminal 110.

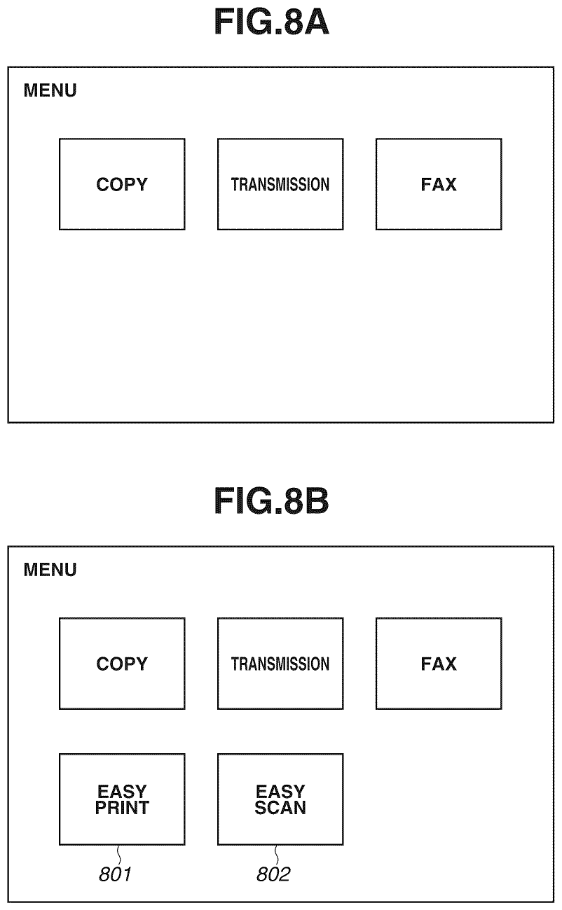

FIGS. 8A and 8B are diagrams illustrating examples of screens each of which is displayed on the operation unit 102 of the MFP 100.

Furthermore, while, with regard to examples of screens each of which is displayed in the MFP 100, only ones needed to describe the first exemplary embodiment are illustrated, naturally, for example, other functions and settings concerning the MFP 100 can be displayed in such screens.

FIG. 6A illustrates an example of a sequence which is performed when the client terminal 110 connects to the MFP 100.

In step 6001, in response to the user issuing an easy application launch instruction to the client terminal 110, the client terminal 110 receives the easy application launch instruction from the user.

Upon receiving the easy application launch instruction, in step 6002, the client terminal 110 launches the easy application 113. In response to the easy application 113 being launched, a connection screen such as that illustrated in FIG. 7A is displayed on the output device connected to the input-output I/F 307 of the client terminal 110.

As illustrated in FIG. 7A, in the connection screen, a connection button 701 operable to connect to the MFP 100 lying near the client terminal 110 and a cancel button 702 are displayed. The cancel button 702 is a button operable to end the easy application 113 without performing connection to the MFP 100.

When, in step 6003, to cause the client terminal 110 to connect to the nearby MFP 100, the user presses the connection button 701, the client terminal 110 detects pressing of the connection button 701 and thus accepts a nearby MFP connection instruction. Furthermore, a configuration in which, in a case where there is a plurality of nearby MFPs, the user selects an MFP targeted for connection from a list of nearby MFPs can be employed.

Upon receiving the nearby MFP connection instruction from the user, in step 6004, the client terminal 110 makes a connection request (connection demand) to the MFP 100 serving as a nearby MFP.

Upon receiving the connection request from the client terminal 110, in step 6005, the MFP 100 performs connection processing. With this processing, in step 6006, a connection for network communication (communication connection) is established between the MFP 100 and the client terminal 110. Furthermore, the connection for network communication between the MFP 100 and the client terminal 110 in the above-mentioned steps 6004 to 6006 is performed by, for example, known Wi-Fi Direct. Furthermore, this connection is performed to, for example, directly connect the client terminal 110 and the MFP 100 to each other via wireless communication and can be implemented not only by Wi-Fi Direct but also by another wireless communication such as Bluetooth®. Moreover, this connection can be configured to be a connection using a wired LAN.

Upon the establishment of a connection for network communication with the MFP 100, in step 6007, the client terminal 110 acquires an Internet Protocol (IP) address of the MFP 100. Here, the client terminal 110 acquires, for example, an IP address which has been set when connection has been performed with Wi-Fi Direct. Moreover, upon the establishment of the connection for network communication, in step 6008, the client terminal 110 performs start-up of an FTP server. Furthermore, while, in the first exemplary embodiment, an example in which FTP is used as a file transfer protocol for scanned electronic data between the MFP 100 and the client terminal 110 is described, the file transfer protocol is not limited to FTP as long as it is a protocol capable of transmitting a file. For example, SSH File Transfer Protocol or Secure File Transfer Protocol (SFTP), Server Message Block (SMB), Web-based Distributed Authoring and Versioning (WebDAV), or HyperText Transfer Protocol (HTTP) can be employed. Thus, in steps 6007 and 6008, the client terminal 110 enables a function for receiving scan data from the MFP 100, according to a communication connection with the MFP 100.

Moreover, in step 6009, the client terminal 110 displays an easy application preparation completion screen such as that illustrated in FIG. 7B on the output device of the client terminal 110.

As illustrated in FIG. 7B, in the easy application preparation completion screen, an end button 703 is displayed, so that pressing the end button 703 enables ending the easy application 113 and disconnecting the client terminal 110 from the MFP 100. Furthermore, a sequence which is performed in response to a disconnection instruction issued from the client terminal 110 is described below with reference to FIG. 6D.

After the establishment of the connection for network communication with the client terminal 110 in the above-mentioned step 6006, then in step 6010, the MFP 100 acquires an IP address of the connected client terminal 110. Here, the MFP 100 acquires, for example, an IP address which has been set when connection has been performed with Wi-Fi Direct.

Additionally, in step 6011, the MFP 100 acquires a user name and a password which are used in FTP for transmitting scanned electronic data. The user name and password can be preliminarily fixedly determined ones between the MFP 100 and the client terminal 110. Alternatively, the user name and password can be unique values generated with use of hash functions in common between the MFP 100 and the client terminal 110 from, for example, the allocated IP address and the date and time. Moreover, a configuration in which, for example, the IP address of the client terminal 110 and the above-mentioned user name and password are transmitted from the client terminal 110 to the MFP 100 and, then, the MFP 100 receives these can be employed.

Additionally, in step 6012, the MFP 100 sets, as a transmission destination of scanned electronic data, the IP address acquired in the above-mentioned step 6010 and the user name and password acquired in the above-mentioned step 6011.

Since preparations for performing scanning have been made by the processing operations in the above-mentioned steps 6010 to 6012, in step 6013, the MFP 100 displays an easy print button 801 and an easy scan button 802 such as those illustrated in FIG. 8B in the menu screen of the operation unit 102. Furthermore, the easy print button 801 is an icon operable to perform print processing for printing print data received from the client terminal 110, which is in a communication state, with the printer unit 103 of the MFP 100. Moreover, the easy scan button 802 is an icon operable to perform scan processing for transmitting scan data obtained by the scanner unit 104 of the MFP 100 reading an original to the client terminal 110, which is in a communication state.

FIG. 8A illustrates an example of a menu screen which is displayed on the operation unit 102 of the MFP 100 in a case where preparations for executing the easy application 113 have not yet been made. In the menu screen illustrated in FIG. 8A, buttons for executing a copy function, a transmission function, and a facsimile (FAX) function are displayed. In response to the preparations for executing the easy application 113 having been made, the MFP 100 displays the easy print button 801 and the easy scan button 802 illustrated in FIG. 8B in the menu screen.

### Screen Transition at the Time of Easy Print Execution

Here, a screen transition occurring at the time of easy print execution by the MFP 100 is described.

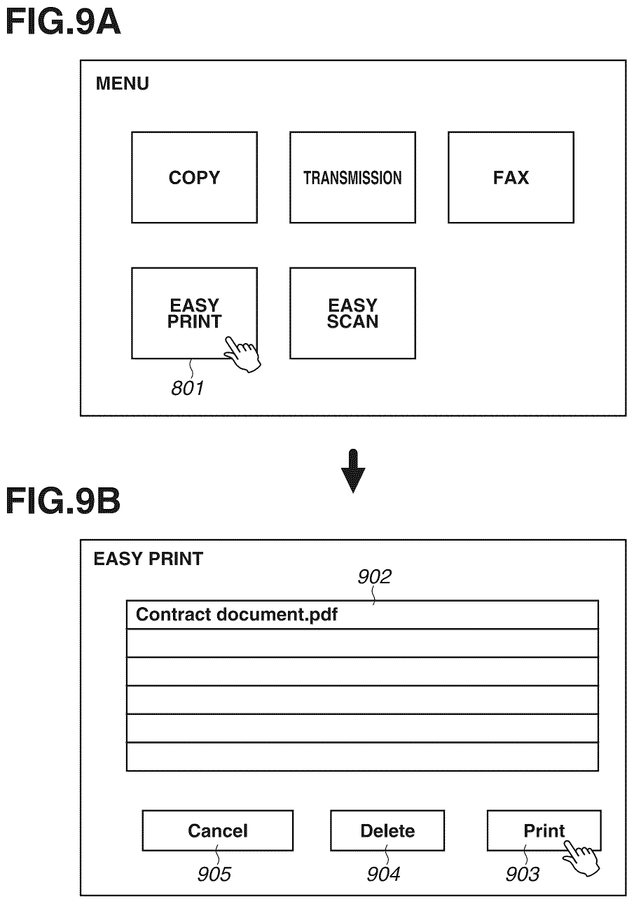

FIGS. 9A and 9B are diagrams illustrating an example of a screen transition occurring at the time of easy print execution by the MFP 100.

FIG. 9A illustrates a menu screen corresponding to the menu screen displayed in the MFP 100 illustrated in FIG. 8B. In response to the user selecting the easy print button 801, the MFP 100 displays an easy print execution screen such as that illustrated in FIG. 9B on the operation unit 102.

As illustrated in FIG. 9B, in the easy print execution screen, a list 902 of pieces of print data transmitted from the client terminal 110 connected for communication in step 6006 illustrated in FIG. 6A is displayed. While, in the example illustrated in FIG. 9B, only one piece of print data is displayed, in a case where a plurality of pieces of print data has been transmitted from the client terminal 110, pieces of print data the number of which corresponds to the number of pieces of print data transmitted from the client terminal 110 are displayed in the print data list 902. Furthermore, a sequence for transmitting print data is described below with reference to FIG. 6B.

Moreover, the easy print execution screen is provided with a print start button 903. In response to the print start button 903 being pressed by the user, the MFP 100 prints all of the pieces of print data displayed in the print data list 902 with the MFP 100 (execution of easy print).

Moreover, the easy print execution screen is provided with a delete button 904. Furthermore, pieces of print data displayed in the print data list 902 are individually selectable. If the delete button 904 is pressed by the user in a state in which print data which the user wants to delete from the print data list 902 has been selected, the MFP 100 deletes the selected print data from the MFP 100. Furthermore, the delete button 904 is provided so as to prevent print data which has been mistakenly transmitted from the client terminal 110 from being printed by the MFP 100.

Moreover, the easy print execution screen is provided with a cancel button 905. The cancel button 905 is provided to end the easy print execution screen without performing printing and return the easy print execution screen to the menu screen illustrated in FIG. 9A.

Furthermore, the menu screen of the MFP 100 which is displayed on the operation unit 102 after easy print has been performed is a screen equivalent to that illustrated in FIG. 8A. In the first exemplary embodiment, on the assumption that the client terminal 110 is unlikely to cause printing and scanning to be performed at a time, execution of easy scan is configured not to be allowed after execution of easy print. Thus, in response to the easy print button 801 being pressed and easy print being performed, the easy print button 801 and the easy scan button 802 are deleted from the menu screen, so that the menu screen transitions to a menu screen such as that illustrated in FIG. 8A.

Furthermore, a configuration in which, in response to the user selecting print data which the user wants to print from the print data list 902 and then pressing the print start button 903, the MFP 100 prints the selected print data can be employed. In the case of this configuration, a configuration in which, as long as any print data which has not yet been printed remains in the print data list 902, the easy print button 801 is not deleted from the menu screen (but the easy scan button 802 is deleted) can be employed. Then, a configuration in which, in a case where all of the pieces of print data displayed in the print data list 902 have been completely printed by easy print, the easy print button 801 is deleted from the menu screen and the menu screen transitions to a menu screen such as that illustrated in FIG. 8A can be employed. Alternatively, a configuration in which, in a case where easy print has been performed and the selected print data has been completely printed by easy print, the easy print button 801 and the easy scan button 802 are deleted from the menu screen and the menu screen transitions to a menu screen such as that illustrated in FIG. 8A can be employed.

Furthermore, whether to perform printing of print data selected by the user from the print data list 902 or whether to perform printing of all of the pieces of print data displayed in the print data list 902 can be made settable by, for example, the user setting, and printing by easy print can be controlled by such setting.

Moreover, a configuration in which, in a case where the user has selected print data from the print data list 902 and has pressed the print start button 903, printing of the selected print data is performed and, in a case where the user has pressed the print start button 903 without selecting print data, printing of all of the pieces of print data displayed in the print data list 902 is performed can be employed.

### Easy Print Execution Sequence

FIG. 6B illustrates an example of a sequence which is performed when an application of the client terminal 110 issues an instruction for printing and the MFP 100 performs printing.

When, in step 6101, the user issues an instruction for execution of printing via an application (not illustrated), such as a document creation application or a spread sheet application, of the client terminal 110, then in step 6102, the client terminal 110 generates print data with use of, for example, a printer driver (not illustrated). Additionally, in step 6103, the client terminal 110 transmits the print data generated in the above-mentioned step 6102 to the MFP 100, which has been connected for communication in step 6006 illustrated in FIG. 6A.

In step 6104, upon receiving the print data transmitted from the client terminal 110, which has been connected for communication in step 6006 illustrated in FIG. 6A, the MFP 100 stores the received print data in the MFP 100 itself in order to make the print data printable by easy print. Furthermore, with the above-mentioned steps 6101 to 6104 being repeated, a plurality of pieces of print data is then stored in the MFP 100.

In step 6105, the user presses the print start button 903 in an easy print execution screen such as that illustrated in FIG. 9B displayed in the MFP 100 and thus issues an instruction for starting printing. In response to this operation, the MFP 100 accepts the instruction for starting printing issued from the user. Upon accepting the instruction for starting printing, in step 6106, the MFP 100 performs print processing of print data currently stored in the MFP 100.

After performing the print processing in the above-mentioned step 6106, then in step 6107, the MFP 100 performs menu screen update processing for, for example, deletion of the easy print button 801 and the easy scan button 802, and thus displays a menu screen such as that illustrated in FIG. 8A. While, here, an example in which the MFP 100 prints all of the pieces of print data which have been transmitted to the MFP 100 in response to the user pressing the print start button 903 to start printing has been described, a configuration in which, as mentioned above, the user selects print data which the user wants to print from the print data list 902 and the MFP 100 prints only the selected print data can be employed. In this case, in response to the completion of printing of all of the pieces of print data, the MFP 100 can delete the easy print button 801.

### Screen Transition at the Time of Easy Scan Execution

Next, a screen transition occurring at the time of easy scan execution by the MFP 100 is described.

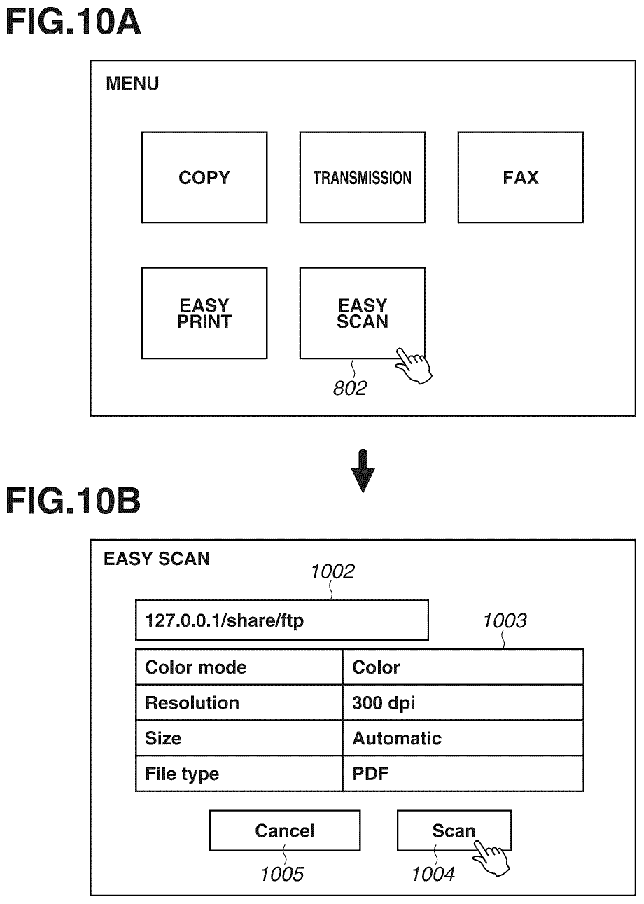

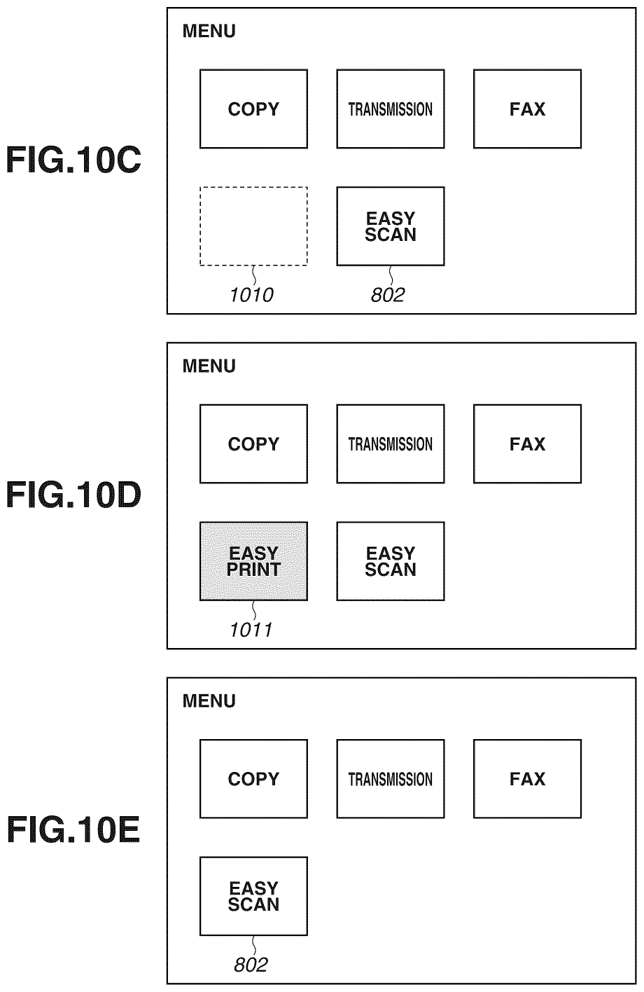

FIGS. 10A, 10B, 10C, 10D, and 10E are diagrams illustrating an example of a screen transition occurring at the time of easy scan execution by the MFP 100.

FIG. 10A illustrates a menu screen corresponding to the menu screen displayed in the MFP 100 illustrated in FIG. 8B. In response to the user selecting the easy scan button 802, the MFP 100 displays an easy scan execution screen such as that illustrated in FIG. 10B on the operation unit 102.

As illustrated in FIG. 10B, in the easy scan execution screen, a transmission destination 1002 for scan data which has been set as mentioned in step 6012 illustrated in FIG. 6A is displayed. In the transmission destination 1002 for scan data, for example, the address of the client terminal 110 is set. Furthermore, for example, a folder serving as the transmission destination is merely an example, and the first exemplary embodiment is not limited to this.

Moreover, in the easy scan execution screen, scan settings 1003 are displayed. The scan settings 1003 are settings concerning scanning for, for example, color mode, resolution, original size, and file type, which the user is allowed to change as needed. The scan settings illustrated in the scan settings 1003 are merely examples, and can be the ones other than the illustrated settings.

Moreover, the easy scan execution screen is provided with a scan start button 1004. In response to the user setting an original in the MFP 100 and pressing the scan start button 1004, the MFP 100 reads the original set in the MFP 100 and thus starts scanning (execution of easy scan).

Moreover, the easy scan execution screen is provided with a cancel button 1005. The cancel button 1005 is provided to end the easy scan execution screen without performing scanning and return the easy scan execution screen to the menu screen illustrated in FIG. 10A.

Furthermore, the menu screen of the MFP 100 which is displayed on the operation unit 102 after easy scan has been performed is a screen such as that illustrated in FIG. 10C. FIG. 10C illustrates an example of a menu screen of the MFP 100 which is displayed after easy scan has been performed. In the first exemplary embodiment, on the assumption that the client terminal 110 is unlikely to cause printing and scanning to be performed at a time, execution of easy print is configured not to be allowed after execution of easy scan. Furthermore, unlike the above-mentioned case of easy print, easy scan might repeat scanning a plurality of times. Therefore, after execution of easy scan, the easy print button 801 is deleted, but the easy scan button 802 remains displayed. Furthermore, a configuration in which the easy print button 801 is deleted and becomes blank as indicated by a dashed square 1010 illustrated in FIG. 10C can be employed, or a configuration in which the easy print button is grayed out and becomes unable to be pressed (becomes disabled) as indicated by a gray square 1011 illustrated in FIG. 10D can be employed. Moreover, the buttons can be displayed in a closed-up manner as illustrated in FIG. 10E. Thus, in response to the easy scan button 802 being pressed and easy scan being performed, the easy print button 801 is, for example, deleted from the menu screen, so that the menu screen transitions to a menu screen such as that illustrated in FIG. 10C (alternatively, can transition to a menu screen such as that illustrated in FIG. 10D or FIG. 10E).

Moreover, in response to the easy scan button 802 being pressed in the menu screen such as that illustrated in FIG. 10C (alternatively, FIG. 10D or FIG. 10E), the MFP 100 displays an easy scan execution screen such as that illustrated in FIG. 10B on the operation unit 102. This enables performing easy scan again.

Furthermore, the MFP 100 has an auto-clear function which, if an operation on the MFP 100 is not performed within a preliminarily set predetermined time, displays a default menu screen (illustrated in FIG. 8A).

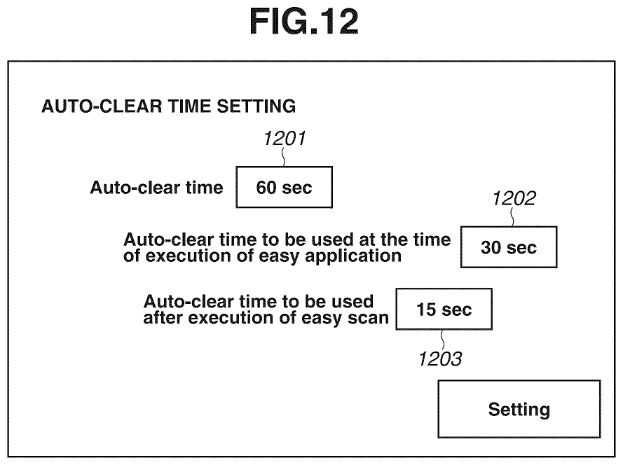

FIG. 12 is a diagram illustrating an example of an auto-clear time setting screen in the auto-clear function of the MFP 100. The auto-clear time setting screen is displayed in response to, for example, a predetermined operation (not illustrated) being performed on the operation unit 102 of the MFP 100. A configuration in which, for example, a setting button is provided in the menu screen and the screen illustrated in FIG. 12 is displayed in response to the setting button being pressed can also be employed.

In the auto-clear time setting screen, a list of auto-clear setting times 1201 to 1203 of the MFP 100 is displayed. The auto-clear setting time 1201 is a time until auto-clear is performed in a case where the MFP 100 is not currently connected to the client terminal 110 by the easy application 113. The auto-clear setting time 1202 is a time until auto-clear is performed in a case where the MFP 100 is currently connected to the client terminal 110 by the easy application 113 and easy scan is not yet performed. The auto-clear setting time 1203 is a time until auto-clear is performed in a case where the MFP 100 is currently connected to the client terminal 110 by the easy application 113 and easy scan has been performed. The user is allowed to set the respective setting times 1201, 1202, and 1203 (auto-clear times) until auto-clear is performed, in the auto-clear time setting screen such as that illustrated in FIG. 12 displayed in the MFP 100.

When a predetermined time (the auto-clear setting time 1203) has elapsed without the above-mentioned menu screen in the state illustrated in FIG. 10C (alternatively, FIG. 10D or FIG. 10E) being operated, the MFP 100 also deletes the easy scan button 802 from the menu screen by the auto-clear function and thus causes the screen displayed on the operation unit 102 to transition to a menu screen equivalent to that illustrated in FIG. 8A.

Furthermore, when the MFP 100 connects to the client terminal 110 and is able to execute the easy application 113, the setting time until auto-clear is performed (the auto-clear setting time 1202 or 1203) can be set shorter than the auto-clear setting time 1201 for a case where MFP 100 is not connected to the client terminal 110. For example, in the case of setting the auto-clear setting time 1202 or 1203, the MFP 100 can perform control in such a manner that the auto-clear setting time 1202 or 1203 can be set to only a time shorter than the auto-clear setting time 1201.

In a situation where the easy application 113 is executed, since the user expressly causes the client terminal 110 to connect to the MFP 100, it is highly likely that the MFP 100 is immediately used. When nevertheless the MFP 100 is not used, since the MFP 100 is in the state of being connected to the client terminal 110, to avoid the inappropriate use of the MFP 100, it is necessary to make the MFP 100 unavailable as soon as possible. Since the case for the menu screen illustrated in FIG. 10C corresponds to the case after execution of easy scan, the auto-clear setting time 1203 for that case can be set further shorter than the auto-clear setting time 1202 to be used before execution of easy scan (which is shorter than the auto-clear setting time 1201). For example, in the case of setting the auto-clear setting time 1203, the MFP 100 can perform control in such a manner that the auto-clear setting time 1203 can be set to only a time shorter than the auto-clear setting time 1202.

### Easy Scan Execution Sequence

FIG. 6C illustrates an example of a sequence which is performed when the MFP 100 performs scanning and transmits scan data to the client terminal 110.

When, in step 6201, the user presses the easy scan button 802 in the menu screen of the MFP 100, then in step 6202, the MFP 100 reads an original set on an automatic document feeder (ADF) (not illustrated) of the MFP 100 and thus performs scan processing according to settings concerning scanning in the scan settings 1003. While, here, an example in which an original is scanned via the ADF is described, a configuration in which scanning is performed with each original placed on a platen glass one by one can be employed.

Additionally, in step 6203, upon the completion of scanning of an original, the MFP 100 generates an image file. Furthermore, performing scanning to generate an image file is a known technique and is, therefore, omitted from description.

Additionally, in step 6204, the MFP 100 connects to the client terminal 110 by FTP with use of the IP address, user name, and password set in step 6012 illustrated in FIG. 6A, and then transmits the image file generated in the above-mentioned step 6203 to the client terminal 110. Furthermore, authentication or file transmission using a file transfer protocol such as FTP is a known technique and is, therefore, omitted from description.

In step 6205, the client terminal 110 performs file reception processing for the file received from the MFP 100, with the FTP server launched in step 6008 illustrated in FIG. 6A, and then stores such scan data in a predetermined storage location.

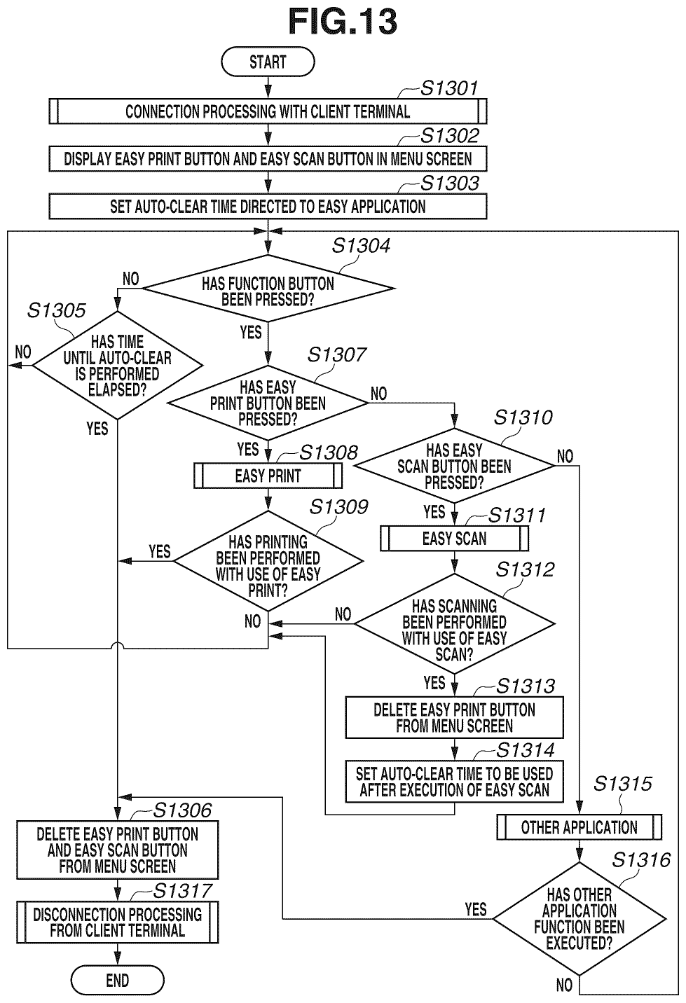

Moreover, after the execution of scan processing in the above-mentioned step 6202, then in step 6206, in response to the transition to a menu screen, the MFP 100 determines deletion of the easy print button 801 and the easy scan button 802, and thus performs update processing for the menu screen. The details of such processing are described below with reference to FIG. 13.

### Sequence of Disconnection Which Client Terminal Performs

FIG. 6D illustrates an example of a sequence which is performed when the client terminal 110 severs connection with the MFP 100.

In step 6301, the user presses the end button 703 in the easy application preparation completion screen such as that illustrated in FIG. 7B and thus issues an instruction for causing the client terminal 110 to disconnect from the MFP 100. In step 6302, in response to the instruction for disconnection, the client terminal 110 makes a disconnection request to the MFP 100.

Upon receiving the disconnection request from the client terminal 110, in step 6303, the MFP 100 performs disconnection processing for Wi-Fi Direct based on the disconnection request, and then in step 6304, the MFP 100 discards a connection for network communication between the MFP 100 and the client terminal 110.

Moreover, in step 6305, the client terminal 110 ends the FTP server.

Additionally, in step 6306, the MFP 100 displays, on the operation unit 102, a menu screen (not illustrated) available for, for example, copying and facsimile (FAX) (a menu screen equivalent to the screen illustrated in FIG. 8A, in which the easy print button 801 and the easy scan button 802 are not displayed), and then ends the processing for the easy application 113.

Moreover, the client terminal 110 can display a disconnection screen such as that illustrated in FIG. 7C indicating that a connection with the MFP 100 has been severed, in a screen of the easy application 113 of the client terminal 110.

Furthermore, a case where, without a connection request being made by the client terminal 110, a connection between the client terminal 110 and the MFP 100 is severed is conceivable. For example, a case where the client terminal 110 is, for example, shut down without any disconnection instruction received or a case where the connection becomes unable to be maintained due to, for example, the movement of the client terminal 110 can be conceivable. Thus, a configuration in which, in a case where the connection has been severed without a connection request being made in the above-mentioned way, the MFP 100 performs updating of a menu screen such as that in the abovementioned step 6306 in response to having detected the disconnection or performs updating of a menu screen after the elapse of a predetermined time by the auto-clear function can be employed.

### Sequence of Disconnection Which MFP Performs

FIG. 6E illustrates an example of a sequence which is performed when the MFP 100 severs connection with the client terminal 110. This corresponds to a case where, for example, when not being operated for a predetermined period, the MFP 100 automatically performs disconnection.

In step 6401, the MFP 100 performs disconnection processing for Wi-Fi Direct, and, in step 6402, the MFP 100 discards a connection for network communication between the MFP 100 and the client terminal 110.

In step 6403, upon detecting a disconnection for network communication from the MFP 100, the client terminal 110 ends the FTP server. Additionally, in step 6404, the client terminal 110 displays a disconnection screen such as that illustrated in FIG. 7C indicating that a connection with the MFP 100 has been severed, in a screen of the easy application 113 of the client terminal 110. Then, in response to the end button 704 being pressed in the disconnection screen, the client terminal 110 ends the easy application 113.

Moreover, in step 6405, the MFP 100 displays, on the operation unit 102, a menu screen (not illustrated) available for, for example, copying and facsimile (FAX) (a menu screen equivalent to the screen illustrated in FIG. 8A, in which the easy print button 801 and the easy scan button 802 are not displayed), and then ends the processing for the easy application 113.

Here, an example of a screen transition which occurs when easy print or easy scan has not been performed in the MFP 100 is described with reference to FIGS. 8A and 8B again.

In a case where the MFP 100 is not operated for a predetermined time in a state in which the menu screen of the MFP 100 described above with reference to FIG. 8B has been displayed, the displayed menu screen transitions to a menu screen such as that illustrated in FIG. 8A by the auto-clear function as mentioned above. The auto-clear setting time in this instance is set to a time (the setting time 1202 illustrated in FIG. 12) shorter than the normal time (the setting time 1201 illustrated in FIG. 12) as mentioned above. In response to a screen transition to the menu screen such as that illustrated in FIG. 8A, the easy print button 801 and the easy scan button 802 are also deleted from the menu screen.

### Screen Transition Occurring When Easy Print has Been Cancelled

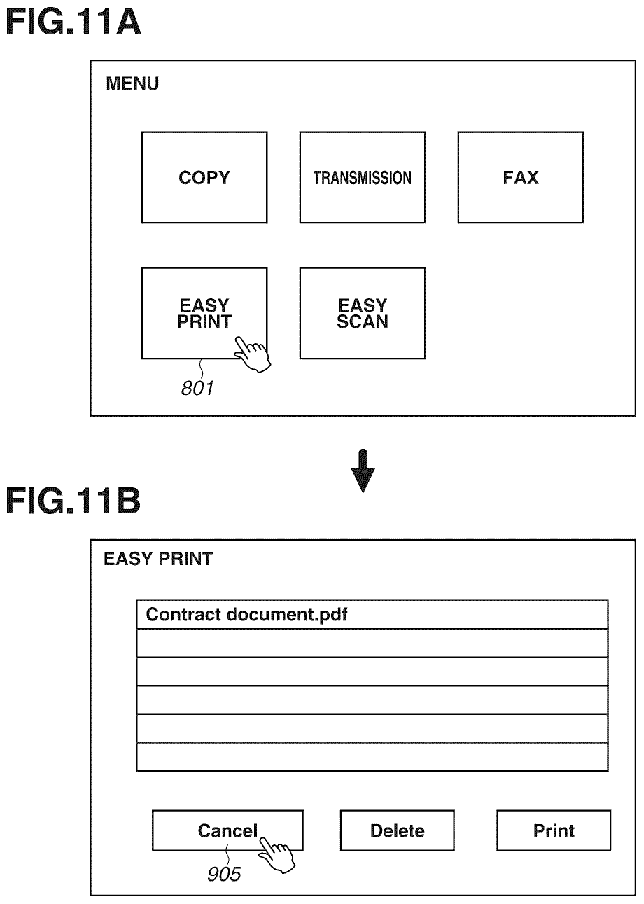

FIGS. 11A and 11B are diagrams illustrating an example of a screen transition occurring in a case where, although an execution screen for easy print has been displayed in the MFP 100, easy print has been cancelled without being performed and the execution screen has returned to the menu screen.

FIG. 11A illustrates a menu screen corresponding to the menu screen of the MFP 100 described above with reference to FIG. 8B.

As illustrated in FIG. 11A, in response to the user selecting the easy print button 801, an easy print execution screen such as that illustrated in FIG. 11B is displayed on the operation unit 102 of the MFP 100. FIG. 11B illustrates a screen equivalent to that illustrated in FIG. 9B.

Here, in response to the cancel button 905 being pressed as illustrated in FIG. 11B, the MFP 100 returns the easy print execution screen to a menu screen of the MFP 100 such as that illustrated in FIG. 11A without performing deletion of the easy print button 801 and the easy scan button 802. Moreover, here, although not illustrated, in a case where, while an execution screen for easy scan (a screen such as that illustrated in FIG. 10B) has been displayed, easy scan has been cancelled by the cancel button 1005 without being performed, a screen transition similar to that for returning to the menu screen illustrated in FIG. 11A also occurs.

FIG. 13 is a flowchart illustrating an example of processing which the MFP 100 performs in the first exemplary embodiment (processing which the MFP 100 performs to perform easy print or easy scan in response to an instruction from the client terminal 110). The processing illustrated in FIG. 13 is performed by a function which is implemented by the CPU 201 reading out a program stored in the flash ROM 210 onto the DRAM 202 and executing the program. In response to the MFP 100 being started up, the processing in the present flowchart is started.

In step S1301, the MFP 100 performs connection processing with the client terminal 110. Specifically, in the connection processing with the client terminal 110, the network control unit 407 and the easy application management unit 411 receive a connection instruction from the client terminal 110, perform processing operations which are performed by the MFP 100 in steps 6004 to 6012 illustrated in FIG. 6A, and thus perform a connection between the MFP 100 and the client terminal 110. Furthermore, the connection processing with the client terminal 110 is not the gist of the present disclosure and, therefore, the detailed description thereof is omitted.

Next, in step S1302, the MFP 100 puts an easy print button and an easy scan button in the menu screen of the MFP 100. Specifically, the easy application management unit 411 instructs the operation control unit 401 to display the easy print button and the easy scan button in the menu screen. The operation control unit 401 displays, on the operation unit 102 of the MFP 100 via the panel I/F 206, a menu screen with the easy print button and the easy scan button added thereto.

Next, in step S1303, the MFP 100 changes the auto-clear setting time to a setting time for the easy application 113. Specifically, the operation control unit 401 acquires a setting value 1202 for the time of easy application execution in a list of auto-clear setting values such as those illustrated in FIG. 12, and the operation control unit 401 sets the acquired setting value as a time until auto-clear is performed.

Next, in step S1304, the operation control unit 401 determines whether a function button in the menu screen has been pressed.

Here, if it is determined that no function button has been pressed (NO in step S1304), the operation control unit 401 advances the processing to step S1305.

In step S1305, the MFP 100 determines whether a time for which no operation on the MFP 100 is being performed has exceeded the setting time until auto-clear is performed. Specifically, the operation control unit 401 measures a time for which no response is received from the panel I/F 206, and determines whether the measured time has exceeded the setting time until auto-clear is performed.

Here, if it is determined that the measured time has not exceeded the setting time until auto-clear is performed (NO in step S1305), the operation control unit 401 returns the processing to step S1304.

On the other hand, if it is determined that the measured time has exceeded the setting time until auto-clear is performed (YES in step S1305), the operation control unit 401 advances the processing to step S1306.

In step S1306, if the easy print button 801 and the easy scan button 802 are currently displayed in the menu screen, the MFP 100 performs deletion of these buttons and thus performs re-displaying of the menu screen. Specifically, the operation control unit 401 displays, on the operation unit 102 of the MFP 100 via the panel I/F 206, a menu screen with the easy print button 801 and the easy scan button 802 removed therefrom. After the processing operation in step S1306, the MFP 100 advances the processing to step S1317. The processing operation in step S1317 is described below.

Moreover, if, in the above-mentioned step S1304, it is determined that a function button has been pressed (YES in step S1304), the operation control unit 401 advances the processing to step S1307.

In step S1307, the operation control unit 401 determines whether the function button determined to have been pressed in the above-mentioned step S1304 is the easy print button 801.

Here, if it is determined that the easy print button 801 has been pressed (YES in step S1307), the MFP 100 advances the processing to step S1308.

In step S1308, the MFP 100 performs the easy print described with reference to FIG. 6B.

Specifically, when the operation control unit 401 performs screen displaying for easy print and the easy print control unit 410 receives a print execution instruction, the MFP 100 performs printing with use of the job control unit 403 and the print processing unit 405. After the processing operation in step S1308, the MFP 100 advances the processing to step S1309.

In step S1309, the MFP 100 determines whether printing has been performed with use of easy print in the above-mentioned step S1308. This processing is performed to check whether cancel has been performed without printing being performed in the above-mentioned step S1308. Specifically, the easy application management unit 411 checks the easy print control unit 410 whether printing has been performed.

Here, if it is determined that printing has been performed with use of easy print (YES in step S1309), the MFP 100 advances the processing to step S1306, in which the MFP 100 deletes both the easy print button 801 and the easy scan button 802 from the menu screen.

On the other hand, if it is determined that printing has not been performed with use of easy print (the cancel button has been pressed) (NO in step S1309), the MFP 100 returns the processing to step S1304, in which the MFP 100 determines again whether a function button in the menu screen has been pressed.

Furthermore, a configuration in which, in response to printing having been performed with use of easy print in the above-mentioned step S1308 and the printing having been completed, the MFP 100 determines a result of the determination in step S1309 as YES and then advances the processing to step S1306 can be employed.

Moreover, if, in the above-mentioned step S1307, it is determined that the easy print button 801 has not been pressed (NO in step S1307), the MFP 100 advances the processing to step S1310.

In step S1310, the operation control unit 401 determines whether the function button determined to have been pressed in the above-mentioned step S1304 is the easy scan button 802.

Here, if it is determined that the easy scan button 802 has been pressed (YES in step S1310), the MFP 100 advances the processing to step S1311.

In step S1311, the operation control unit 401 and the easy scan control unit 409 perform the easy scan described with reference to FIG. 6C. Specifically, the operation control unit 401 performs screen displaying for easy scan, and the easy scan control unit 409 receives a scan execution instruction. The easy scan control unit 409 performs scanning with use of the job control unit 403, the reading processing unit 406, and the network control unit 407, and then transmits scan data to the client terminal 110.

In step S1312, the MFP 100 determines whether scanning has been performed with use of easy scan in the above-mentioned step S1311. This processing is performed to check whether cancel has been performed without scanning being performed in the above-mentioned step S1311. Specifically, the easy application management unit 411 checks the easy scan control unit 409 whether scanning has been performed.

Here, if it is determined that scanning has not been performed with use of easy scan (the cancel button has been pressed) (NO in step S1312), the MFP 100 returns the processing to step S1304, in which the MFP 100 determines again whether a function button in the menu screen has been pressed.

On the other hand, if it is determined that scanning has been performed with use of easy scan (YES in step S1312), the MFP 100 advances the processing to step S1313.

In step S1313, as mentioned above with reference to FIG. 10C, the MFP 100 deletes only the easy print button 801 from the menu screen and thus performs re-displaying of the menu screen. Specifically, the operation control unit 401 displays, on the operation unit 102 of the MFP 100 via the panel I/F 206, a menu screen with the easy print button 801 removed therefrom.

Next, in step S1314, the easy application management unit 411 changes the auto-clear setting time to a setting time for the easy application 113. Specifically, the operation control unit 401 acquires a setting value 1203 for the time after easy scan execution in a list of auto-clear setting values such as those illustrated in FIG. 12, and the operation control unit 401 sets the acquired setting value 1203 for the time after easy scan execution as a time until auto-clear is performed. After that, the MFP 100 returns the processing to step S1304, in which the MFP 100 determines again whether a function button in the menu screen has been pressed.

Moreover, if, in the above-mentioned step S1310, it is determined that the easy scan button 802 has not been pressed (NO in step S1310), the MFP 100 advances the processing to step S1315.

In step S1315, the MFP 100 determines that a button corresponding to an application function other than easy print and easy scan, such as copying or facsimile (FAX), has been selected on the operation unit 102, and then performs processing for executing the other application function corresponding to the selected button. Specifically, each function control unit (not illustrated) of the MFP 100 performs processing for the selected function.

Next, in step S1316, the MFP 100 determines whether the other application function has been executed in the above-mentioned step S1315. This processing is performed to check whether cancel has been performed without the other application function being executed in the above-mentioned step S1315. Specifically, the easy application management unit 411 checks whether the application function selected on the operation unit 102 of the MFP 100 has been executed by the corresponding function control unit (not illustrated).

Here, if it is determined that cancel has been performed without the other application function being executed (NO in step S1316), the MFP 100 returns the processing to step S1304, in which the MFP 100 determines again whether a function button in the menu screen has been pressed.

On the other hand, if it is determined that the other application function has been executed (YES in step S1316), the MFP 100 determines that the user does not intend to execute any function of the easy application 113, and thus advances the processing to step S1306, in which the MFP 100 deletes the easy print button 801 and the easy scan button 802 from the menu screen. After the processing operation in step S1306, the MFP 100 advances the processing to step S1317.

In step S1317, the MFP 100 performs disconnection processing from the client terminal 110 described with reference to FIG. 6E. Specifically, the easy application management unit 411 performs disconnection processing from the client terminal 110 via the network control unit 407 and thus discards a connection with the client terminal 110. At this time, the MFP 100 performs deletion of print data which has been transmitted from the client terminal 110 but has not been printed, with use of the data storage unit 402.

While, in the description of the first exemplary embodiment, a combination of an easy print application button and an easy scan application button is used, a combination of the other types of applications can be employed. Moreover, the number of application buttons which are used as a combination is not limited to two, and a combination of more application buttons can also be applied to the first exemplary embodiment.

As described above, in a case where the user uses an easy application with a shared MFP with the client terminal 110 and the MFP 100 connected to each other, a button is automatically deleted according to an operating state of the user, so that it is possible to appropriately hide an application button at timing when the application button has become unnecessary.

Thus, even in a case where the user uses an MFP which is used in a shared manner, such as an MFP installed in, for example, a coworking space or shared office, with the MFP and a client terminal of the user connected to each other, it is possible to prevent or reduce the occurrence of a situation in which an application button displayed in the MFP is operated and fraudulently used by another user. Moreover, it is possible to delete an icon at appropriate timing corresponding to a function associated with the icon, such as printing or scanning.

In the above-described first exemplary embodiment, a configuration in which, when an application other than easy print and easy scan has been executed, the easy print button and the easy scan button are deleted has been described. In a second exemplary embodiment of the present disclosure, a configuration in which it is possible to set an operation which is to be performed when an application other than easy print and easy scan has been executed is described.

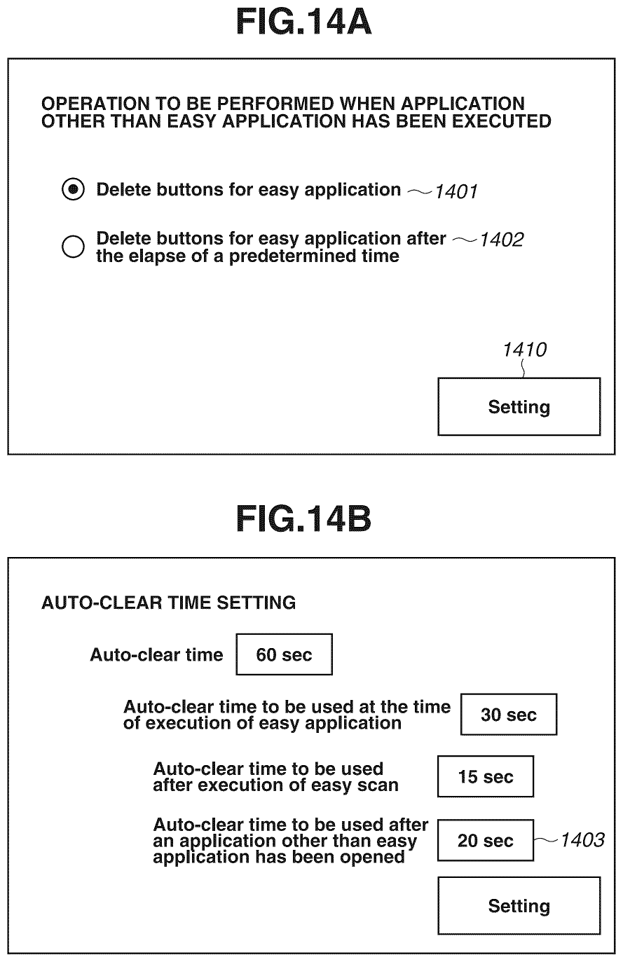

FIG. 14A is a diagram illustrating an example of a screen for setting an operation to be performed when an application other than easy print and easy scan (i.e., another application) has been executed. This screen is displayed, for example, in response to the user performing a predetermined operation (not illustrated) on the operation unit 102 of the MFP 100. A configuration in which, for example, a setting button is provided in a menu screen and, in response to the setting button being pressed, the screen illustrated in FIG. 14A is displayed can also be employed.

A radio button 1401 is operable to select a setting in which the easy print button and the easy scan button are deleted immediately after another application has been executed. A radio button 1402 is operable to select a setting in which the easy print button and the easy scan button are deleted after the elapse of a predetermined time after another application has been executed. The user is allowed to select only one of the radio button 1401 and the radio button 1402, and is able to fix the setting by pressing a setting button 1410. Thus, the user is able to selectively set the setting corresponding to the radio button 1401 and the setting corresponding to the radio button 1402. Furthermore, in the second exemplary embodiment, as illustrated in FIG. 14B, a setting 1403 of auto-clear time after an application other than the easy applications has been opened is added to the auto-clear time setting screen described above with reference to FIG. 12.

In a case where the setting corresponding to the radio button 1402 is currently set, when an application other than easy print and easy scan has been executed, the MFP 100 sets the auto-clear time set in the setting 1403. Therefore, by performing the setting corresponding to the radio button 1402, after having opened an application screen other than easy print and easy scan and having executed the function thereof, the user becomes able to continue to use the easy application.

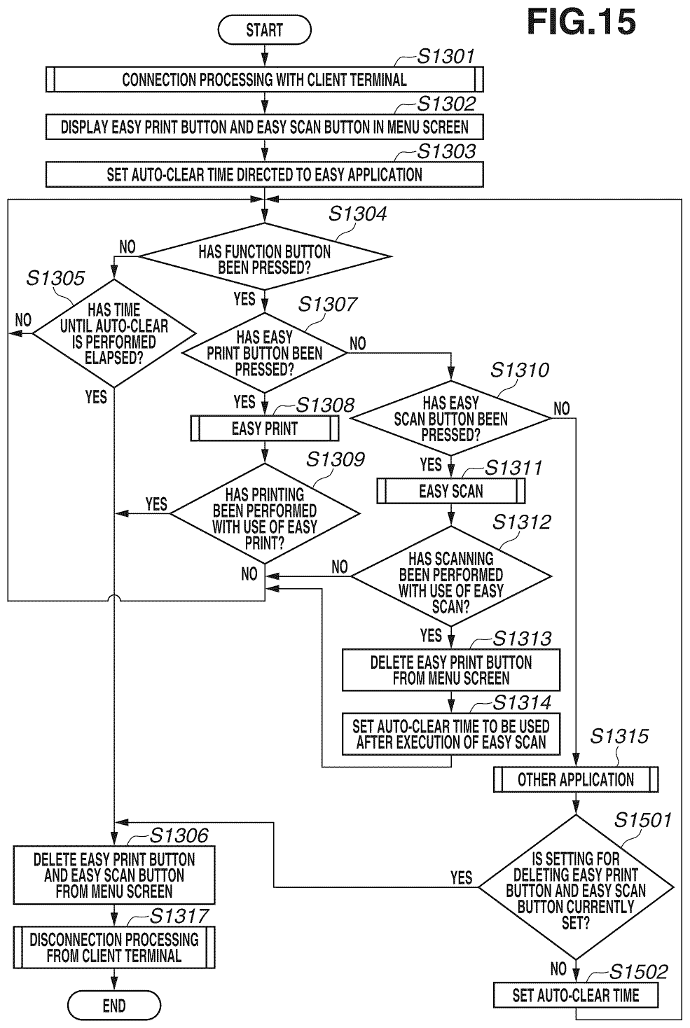

FIG. 15 is a flowchart illustrating an example of processing which the MFP 100 performs in the second exemplary embodiment (processing for easy print and easy scan in which an operation to be performed when an application other than easy print and easy scan has been executed is made selectable). The processing illustrated in FIG. 15 is performed by a function which is implemented by the CPU 201 reading out a program stored in the flash ROM 210 onto the DRAM 202 and executing the program. In response to the MFP 100 being started up, the processing in the present flowchart is started. Furthermore, the same steps as those illustrated in FIG. 13 are assigned the respective same step numbers as those illustrated in FIG. 13 and are omitted from description here.

In the second exemplary embodiment, after executing the other application in step S1315, the MFP 100 advances the processing to step S1501.

In step S1501, the easy application management unit 411 checks whether a setting for deleting the easy print button and the easy scan button when an application other than easy print and easy scan has been executed (the setting corresponding to the radio button 1401 illustrated in FIG. 14A) is currently set.

Here, if it is determined that a setting for deleting the easy print button and the easy scan button (the setting corresponding to the radio button 1401 illustrated in FIG. 14A) is currently set (YES in step S1501), the MFP 100 advances the processing to step S1306, in which the easy application management unit 411 deletes the easy print button and the easy scan button.

On the other hand, if it is determined that a setting for deleting the easy print button and the easy scan button after the elapse of a predetermined time (the setting corresponding to the radio button 1402 illustrated in FIG. 14A) is currently set (NO in step S1501), the MFP 100 advances the processing to step S1502.

In step S1502, the MFP 100 changes the auto-clear setting time to a setting time which is to be set when an application other than easy print and easy scan has been executed (the time in the setting 1403 illustrated in FIG. 14B). Specifically, the operation control unit 401 acquires a setting value in the setting 1403 in a list of auto-clear setting values such as that illustrated in FIG. 14B, and the operation control unit 401 sets the setting value in the setting 1403 as a time until auto-clear is performed. After that, the MFP 100 returns the processing to step S1304, in which the MFP 100 determines again whether a function button in the menu screen has been pressed.

With the above-described processing performed, even after having opened an application screen other than easy print and easy scan and having executed the function thereof, it also becomes able to continue to use the easy application.

In the above-described first exemplary embodiment, a configuration in which, in a case where an operation on the MFP 100 is not performed for a predetermined time, the easy application button (the easy print button and the easy scan button) is deleted by the auto-clear function and the MFP 100 is disconnected from the client terminal 110 has been described. In a third exemplary embodiment of the present disclosure, an example in which, even when the easy application button is deleted by the auto-clear function, the MFP 100 maintains a connection with the client terminal 110 for a predetermined time is described. This is provided to save the trouble and time for, for example, reconnection in a case where, for example, although the user has connected the MFP 100 and the client terminal 110 to each other, the user has inadvertently failed to perform an operation on the MFP 100. For example, in a case where, in easy print, although print data has been transmitted from the client terminal 110 to the MFP 100, the user has failed to perform an operation on the MFP 100 within the auto-clear time, the easy application button is deleted. However, in the third exemplary embodiment, even in such a case, a connection with the client terminal 110 is maintained for a predetermined time and, moreover, print data which has been transmitted to the MFP 100 is kept for a predetermined time without being deleted. In this case, even only restoring the easy application button causes the print data which has previously been transmitted to the MFP 100 to return to a printable state. Therefore, the user becomes able to easily and quickly resume an operation on the MFP 100.

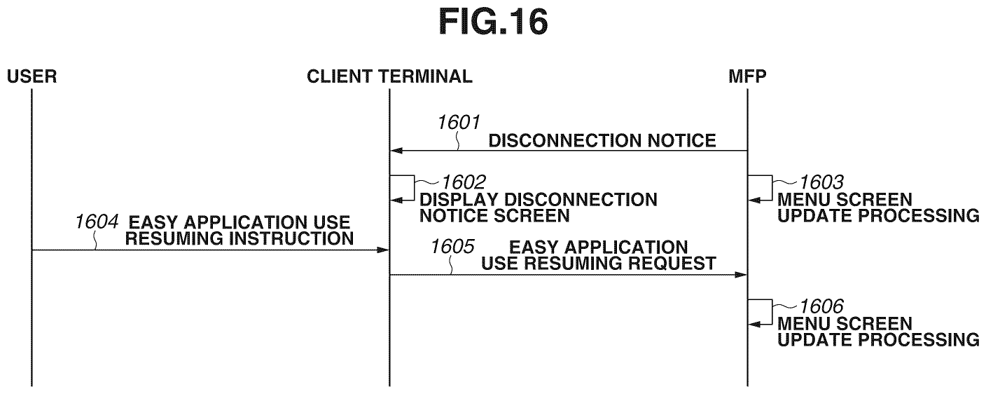

FIG. 16 is a diagram illustrating an example of a sequence which is performed when the auto-clear time has elapsed without the easy application 113 being executed in the third exemplary embodiment. Furthermore, in a case where the easy application 113 has been executed, the present sequence is not applied.

In step 1601, in response to the auto-clear time being reached without the easy application 113 being executed, the MFP 100 starts the present sequence and transmits a disconnection notice to the client terminal 110.

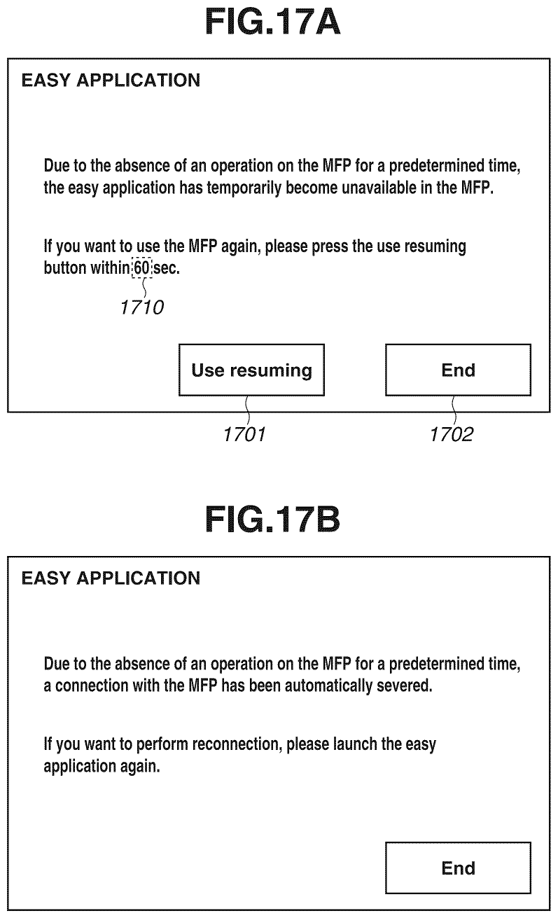

Upon receiving the disconnection notice from the MFP 100, in step 1602, the client terminal 110 displays a disconnection notice screen such as that illustrated in FIG. 17A on the output device of the client terminal 110.

As illustrated in FIG. 17A, the disconnection notice screen includes a notification indicating that, due to the absence of an operation on the MFP 100 for a predetermined time, the easy application 113 has become unavailable, a use resuming button 1701 operable to maintain a connection with the MFP 100 and resume use of the easy application 113, and an end button 1702 operable to sever a connection with the MFP 100. Furthermore, a notification about a time limit 1710 for depressing of the use resuming button 1701 (in the example illustrated in FIG. 17A, “within 60 sec”) is assumed to be displayed in a countdown manner with time.

In step 1603 illustrated in FIG. 16, in response to the auto-clear time being reached, the MFP 100 deletes the easy print button 801 and the easy scan button 802 from the menu screen. However, in the third exemplary embodiment, the MFP 100 only deletes the buttons from the menu screen, but does not perform deletion of print data which is currently stored in the MFP 100 and also does not discard a connection with the client terminal 110.

In step 1604, in a case where, as if the user inadvertently has not performed an operation on the MFP 100, the user has not performed an operation on the MFP 100 for a predetermined time but wants to resume use of the easy application 113, the user presses the use resuming button 1701 illustrated in FIG. 17A and thus issues an easy application use resuming instruction to the client terminal 110. In step 1605, in response to the easy application use resuming instruction, the client terminal 110 makes an easy application use resuming request to the MFP 100.

In step 1606, upon receiving the easy application use resuming request from the client terminal 110, the MFP 100 displays a menu screen with the easy print button 801 and the easy scan button 802 added thereto. In this case, since print data which has been transmitted from the client terminal 110 remains stored and a connection with the client terminal 110 is also remaining, the MFP 100 only needs to restore the buttons. This enables the user to operate the easy print button 801 or the easy scan button 802 on the MFP 100 and thus perform easy print or easy scan with the MFP 100.

Furthermore, in a case where the user does not want to use the easy application 113, the user presses an end button 1702 and thus issues an end instruction to the client terminal 110 (not illustrated). In response to the end instruction, the client terminal 110 discards a connection with the MFP 100. In this case, a sequence equivalent to that illustrated in FIG. 6D is performed.

Moreover, if the user leaves the MFP 100 unattended for a predetermined time while the disconnection notice screen illustrated in FIG. 17A is kept displayed, the MFP 100 discards a connection with the client terminal 110. In this case, a sequence equivalent to that illustrated in FIG. 6E is performed. Specifically, upon detecting a disconnection for network communication from the MFP 100, the client terminal 110 ends the FTP server. Additionally, the client terminal 110 displays a disconnection screen such as that illustrated in FIG. 17B indicating that a connection with the MFP 100 has been severed, in a screen of the easy application 113 of the client terminal 110. Then, in response to the end button being pressed in the disconnection screen, the client terminal 110 ends the easy application 113.

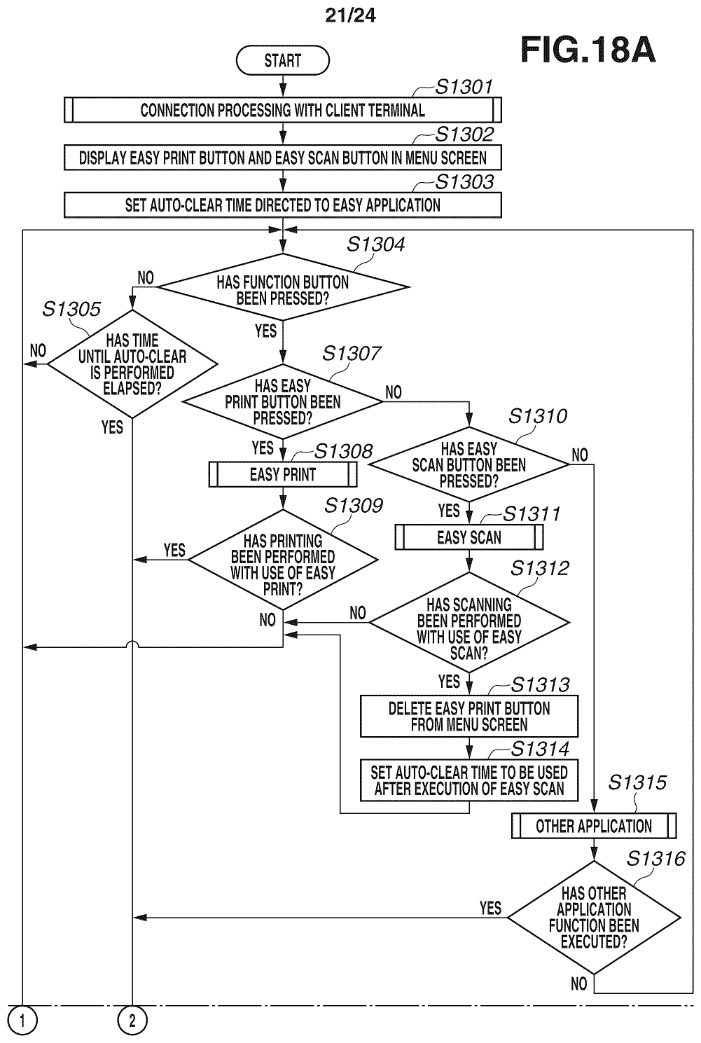

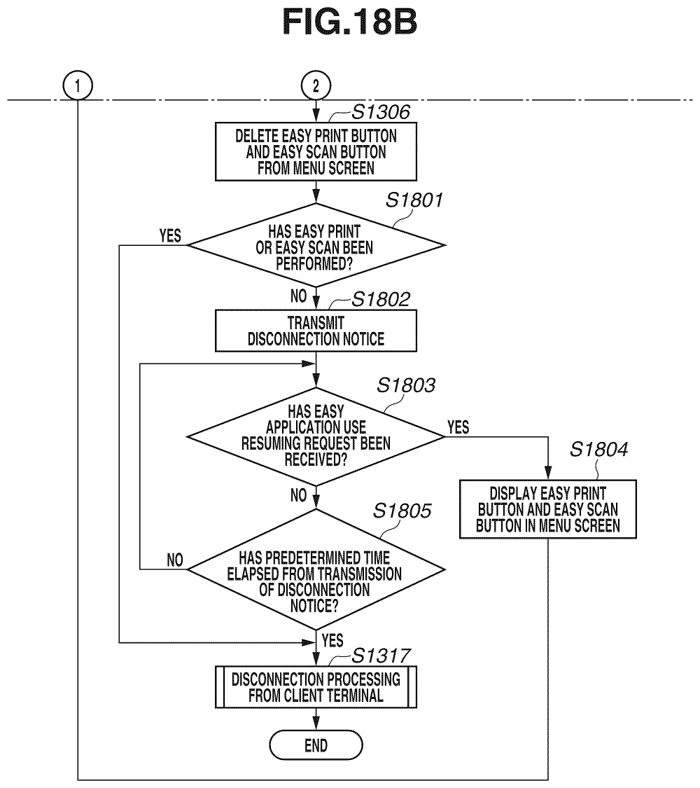

FIGS. 18A and 18B are flowcharts illustrating an example of processing which the MFP 100 performs in the third exemplary embodiment (processing for enabling resuming use of the easy application 113 after, due to the absence of an operation on the MFP 100 for a predetermined time without the easy application 113 being executed, the easy print button 801 and the easy scan button 802 have been deleted by the auto-clear function). The processing illustrated in FIGS. 18A and 18B is performed by a function which is implemented by the CPU 201 reading out a program stored in the flash ROM 210 onto the DRAM 202 and executing the program.

In response to the MFP 100 being started up, the processing in the present flowcharts is started. Furthermore, the same steps as those illustrated in FIG. 13 are assigned the respective same step numbers as those illustrated in FIG. 13 and are omitted from description here.

After deleting the easy print button 801 and the easy scan button 802 from the menu screen in step S1306, the MFP 100 in the third exemplary embodiment advances the processing to step S1801.

In step S1801, the MFP 100 checks whether easy print or easy scan has been performed. Specifically, the easy application management unit 411 checks the easy scan control unit 409 or the easy print control unit 410 whether scanning or printing has been performed.

Here, if it is determined that any one of easy print and easy scan has been performed (YES in step S1801), the MFP 100 advances the processing to step S1317, the MFP 100 performs disconnection processing from the client terminal 110.

On the other hand, if it is determined that neither of easy print and easy scan has been performed (NO in step S1801), the MFP 100 advances the processing to step S1802.

In step S1802, the MFP 100 transmits a disconnection notice to the client terminal 110. Specifically, the easy application management unit 411 transmits, via the network control unit 407, a disconnection notice to the client terminal 110 so as to cause the client terminal 110 to display the screen illustrated in FIG. 17A.

Next, in step S1803, the MFP 100 checks whether an easy application use resuming request has been received from the client terminal 110. Specifically, the easy application management unit 411 checks whether the easy application use resuming request has come from the network control unit 407.

Here, if it is determined that the easy application use resuming request has been received from the client terminal 110 (YES in step S1803), the MFP 100 advances the processing to step S1804.

In step S1804, in response to the easy application use resuming request coming from the client terminal 110, the MFP 100 displays the easy print button 801 and the easy scan button 802 in the menu screen again, and then returns the processing to step S1304. Specifically, the easy application management unit 411 instructs the operation control unit 401 to display the easy print button 801 and the easy scan button 802 in the menu screen. The operation control unit 401 performs, via the panel I/F 206, redisplaying of a menu screen with the easy print button 801 and the easy scan button 802 added thereto on the operation unit 102 of the MFP 100.

Moreover, if, in the above-mentioned step S1803, it is determined that the easy application use resuming request has not been received from the client terminal 110 (NO in step S1803), the MFP 100 advances the processing to step S1805.

In step S1805, the MFP 100 checks whether a predetermined time has elapsed from when the MFP 100 has transmitted the disconnection notice to the client terminal 110 in the above-mentioned step S1802. Specifically, the easy application management unit 411 performs such checking by measuring an elapsed time from the transmission of the disconnection notice in step S1802. Furthermore, the elapsed time can be a previously determined time or can be a time which the administrator of the MFP 100 is able to set.

Here, if it is determined that the predetermined time has not elapsed (NO in step S1805), the MFP 100 returns the processing to step S1803, in which the MFP 100 checks again whether an easy application use resuming request has been received from the client terminal 110.

On the other hand, if it is determined that the predetermined time has elapsed (YES in step S1805), the MFP 100 advances the processing to step S1317, in which the MFP 100 performs disconnection processing from the client terminal 110.

With the above-described processing performed, for example, even if the user inadvertently fails to perform an operation on the operation unit 102 of the MFP 100 so that the easy print button 801 and the easy scan button 802 are deleted from the menu screen and the easy application 113 becomes unavailable, the user becomes able to quickly and easily resume use of the easy application 113.

Furthermore, a configuration in which, in a case where the user has not perform an operation on the MFP 100 within an auto-clear time, deletion of the easy application button and severing of a connection with the client terminal 110 are performed but only print data is kept stored can be employed as a modification example. Even in this case, a screen including the use resuming button 1701 and the end button 1702 similar to that illustrated in FIG. 17A is displayed in the client terminal 110. In the case of wanting to resume use of the MFP 100, the user presses the use resuming button 1701 and thus issues a use resuming instruction to the client terminal 110. In response to the use resuming instruction, the client terminal 110 makes a reconnection request to the MFP 100. Upon receiving the reconnection request from the client terminal 110, the MFP 100 performs connection processing with the client terminal 110. This causes the MFP 100 and the client terminal 110 to reconnect to each other. Additionally, the MFP 100 displays a menu screen with the easy print button 801 and the easy scan button 802 added thereto. This enables the user to easily resume use of the easy application 113.

In the above-described first exemplary embodiment, a configuration in which, if easy print is performed, the easy print button 801 and the easy scan button 802 are deleted and a connection with the client terminal 110 is severed has been described. Moreover, a configuration in which, if easy scan is performed, the easy print button 801 is deleted according to an operation has been described. In a fourth exemplary embodiment of the present disclosure, an example in which, after easy print or easy scan is performed, whether to continue the easy application 113 is checked or a switch for setting whether to continue easy print after easy print is performed is provided is described.

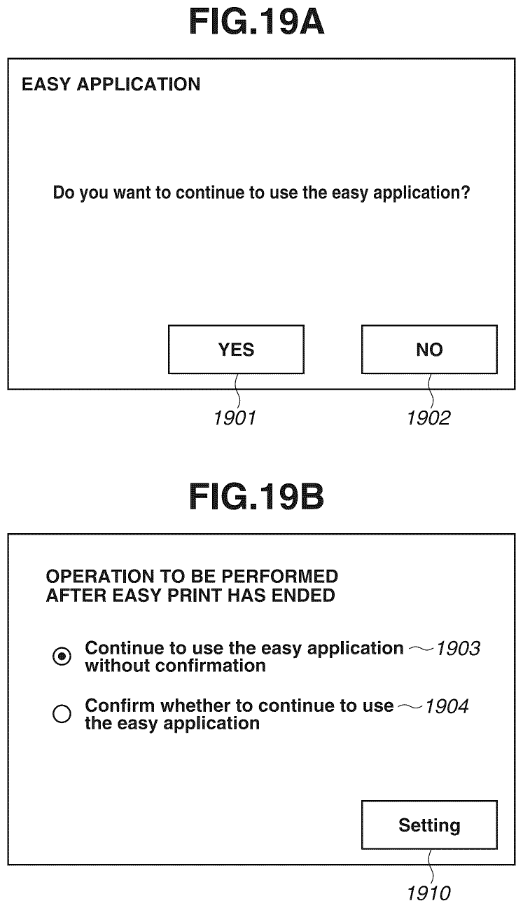

FIGS. 19A and 19B are diagrams illustrating examples of screens each of which is displayed in the MFP 100 concerning continuation of processing to be performed by the easy application 113 in the fourth exemplary embodiment.

FIG. 19A illustrates an example of a screen for confirming whether to continue to use the easy application 113 (a confirmation screen), which the MFP 100 displays on the operation unit 102 after the function of easy print or easy scan has been executed. The confirmation screen is provided with a YES button 1901 and a NO button 1902.

In response to the user pressing the YES button 1901 in the confirmation screen displayed in the MFP 100, the MFP 100 causes the confirmation screen to transition to the menu screen without deleting the easy print button 801 and the easy scan button 802. This enables the user to re-perform easy print or easy scan again.

On the other hand, in a case where the user has pressed the NO button 1902 in the confirmation screen displayed in the MFP 100, since non-use of the easy application 113 has been selected, the MFP 100 deletes the easy print button 801 and the easy scan button 802 and severs a connection with the client terminal 110.

FIG. 19B illustrates an example of a setting screen which is displayed in the MFP 100 to confirm whether to continue to use the easy application 113 again after easy print has ended. The setting screen is displayed in response to, for example, a predetermined operation (not illustrated) being performed on the operation unit 102 of the MFP 100. A configuration in which, for example, a setting button is provided in the menu screen and the screen illustrated in FIG. 19B is displayed in response to the setting button being pressed can also be employed.

In the setting screen such as that illustrated in FIG. 19B, the administrator preliminarily sets an operation which is to be performed after easy print has ended.

As illustrated in FIG. 19B, the setting screen is provided with radio buttons 1903 and 1904. The radio button 1903 is a button operable to select a setting for continuing the easy application 113 without confirmation after the execution of easy print has ended. The radio button 1904 is a button operable to select a setting for confirming continuation of the easy application 113 after the execution of easy print has ended. The user is allowed to bring only one of the radio button 1903 and the radio button 1904 into a selected state and is able to fix the setting by pressing a setting button 1910.

In a case where the setting corresponding to the radio button 1903 is currently selected, after the execution of easy print has ended, the MFP 100 returns the setting screen to the menu screen without user confirmation and without deleting the easy print button 801 and the easy scan button 802, thus enabling the easy application 113 to be executed again.

Moreover, in a case where the setting corresponding to the radio button 1904 is currently selected, after the execution of easy print has ended, the MFP 100 displays a confirmation screen such as that illustrated in FIG. 19A, thus enabling the user to designate continuation of processing to be performed by the easy application 113.

While, in the fourth exemplary embodiment, an example in which a screen for confirming continuation of processing to be performed by the easy application 113 is displayed has been described, any type of setting can be selected as long as it is a setting capable of setting an operation to be performed after the execution of the easy application 113, such as an operation of ending the easy application 113 without confirmation. For example, the confirmation screen illustrated in FIG. 19A can be provided with a third radio button for performing a setting of ending the easy application 113. In a case where the setting corresponding to the third radio button is currently selected, after the execution of easy print has ended, as in the first exemplary embodiment, the MFP 100 is assumed to delete the easy print button 801 and the easy scan button 802 and sever a connection with the client terminal 110.

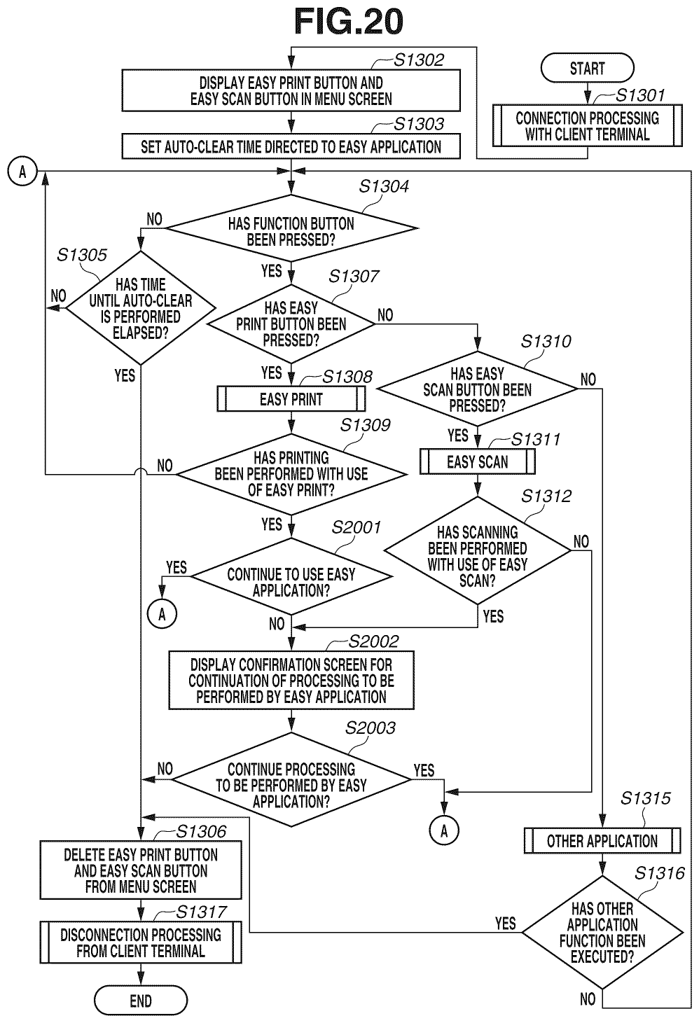

FIG. 20 is a flowchart illustrating an example of processing which the MFP 100 performs in the fourth exemplary embodiment (processing for enabling determining whether to continue processing to be performed by the easy application 113). The processing illustrated in FIG. 20 is performed by a function which is implemented by the CPU 201 reading out a program stored in the flash ROM 210 onto the DRAM 202 and executing the program. In response to the MFP 100 being started up, the processing in the present flowchart is started. Furthermore, the same steps as those illustrated in FIG. 13 are assigned the respective same step numbers as those illustrated in FIG. 13 and are omitted from description here.

If, in step S1309 in the fourth exemplary embodiment, it is determined that printing has been performed in step S1308 with use of easy print (YES in step S1309), the MFP 100 advances the processing to step S2001.

In step S2001, the easy application management unit 411 determines whether to continue the easy application 113. Specifically, in the above-mentioned setting screen such as that illustrated in FIG. 19B, the easy application management unit 411 determines whether a setting for continuing to use the easy application 113 without confirmation (the setting corresponding to the radio button 1903) is currently selected.

Here, if it is determined that the setting for continuing to use the easy application 113 without confirmation (the setting corresponding to the radio button 1903) is currently selected (YES in step S2001), the MFP 100 returns the processing to step S1304, in which the MFP 100 determines again whether a function button in the menu screen has been pressed.

On the other hand, if it is determined that a setting for confirming continuation of the easy application 113 (the setting corresponding to the radio button 1904) is currently selected (NO in step S2001), the MFP 100 advances the processing to step S2002.

Moreover, if, in step S1312, it is determined that scanning has been performed in step S1311 with easy scan (YES in step S1312), the MFP 100 also advances the processing to step S2002.

In step S2002, the MFP 100 displays a confirmation screen for continuation of processing to be performed by the easy application 113 such as that illustrated in FIG. 19A. Specifically, the easy application management unit 411 instructs the operation control unit 401 to display, via the panel I/F 206, the confirmation screen for continuation of processing to be performed by the easy application 113 on the operation unit 102 of the MFP 100.

Next, in step S2003, the MFP 100 determines whether to continue processing to be performed by the easy application 113. Specifically, the easy application management unit 411 checks, with use of the operation control unit 401 via the panel I/F 206, which of the YES button 1901 and the NO button 1902 has been pressed in the confirmation screen for continuation of processing to be performed by the easy application 113.

If it is determined that the YES button 1901 has been pressed, i.e., if it is determined to continue processing to be performed by the easy application 113 (YES in step S2003), the MFP 100 returns the processing to step S1304, in which the MFP 100 determines again whether a function button in the menu screen has been pressed.

On the other hand, if it is determined that the NO button 1902 has been pressed, i.e., if it is determined not to continue processing to be performed by the easy application 113 (NO in step S2003), the MFP 100 advances the processing to step S1306, in which the MFP 100 deletes the easy print button 801 and the easy scan button 802 from the menu screen.

With the above-described processing performed, in the case of wanting to continue to use the easy application 113, the user becomes able to continue processing to be performed by the easy application 113 according to the user's convenience.

Furthermore, in a case where the present disclosure is applied to an image processing apparatus which is not equipped with a scanner unit, although an easy scan button is not displayed, displaying and deletion of an easy print button are assumed to be controlled in a manner similar to that in the present disclosure.

Moreover, in a case where the present disclosure is applied to an image processing apparatus which is not equipped with a printer unit, although an easy print button is not displayed, displaying and deletion of an easy scan button are assumed to be controlled in a manner similar to that in the present disclosure.

As described above, according to each exemplary embodiment, it is possible to delete an icon operable to perform printing or scanning which is displayed on an operation unit of an image processing apparatus in response to a communication connection with an information processing apparatus such as a mobile terminal being established (the easy print button 801 or the easy scan button 802), at appropriate timing deemed to be a time when the use thereof has ended (has become unnecessary). This enables satisfying both ensuring of a security associated with use of the image processing apparatus (prevention of improper use by another person) and an increase in usability. As a result, it becomes possible to safely and conveniently use an image processing apparatus which is installed in, for example, a coworking space or shared office.

Furthermore, the structures of the above-mentioned various pieces of data and the contents thereof are not limited to those described above, and, naturally, can be altered to various structures and contents according to use applications and purposes.

The present disclosure can be embodied as exemplary embodiments serving as, for example, a system, an apparatus, a method, a program, and a storage medium. Specifically, the present disclosure can be applied to a system composed of a plurality of pieces of equipment, or can be applied to an apparatus composed of one piece of equipment.

According to aspects of the present disclosure, it is possible to delete an icon operable to perform printing or scanning which is displayed on an operation unit of an image processing apparatus, at appropriate timing, and it also becomes possible to satisfy both ensuring of a security associated with use of the image processing apparatus and an increase in usability. As a result, it becomes possible to safely and conveniently use an image processing apparatus which is installed in, for example, a coworking space or shared office.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084011 filed May 23, 2024, which is hereby incorporated by reference herein in its entirety.

What is claimed is:

1. An image processing apparatus including a scanner, the image processing apparatus comprising:
a control unit; and
a connection unit,
wherein, according to a communication connection established, in response to a connection request from an information processing apparatus which lies close to the image processing apparatus, by the connection unit with the information processing apparatus, the control unit performs displaying, on an operation unit of the image processing apparatus, of a first icon operable to perform print processing for printing, by the image processing apparatus, print data received from the information processing apparatus and a second icon operable to perform scan processing for transmitting, to the information processing apparatus, scan data obtained by the scanner reading an original, and
wherein, in a case where print processing using the first icon has been performed, the control unit performs deletion of the first icon and the second icon.

2. The image processing apparatus according to claim 1, wherein the control unit performs deletion of the first icon and the second icon in response to printing of print data received from the information processing apparatus having been completed in the print processing.

3. The image processing apparatus according to claim 1, wherein, in a case where scan processing using the second icon has been performed, the control unit performs deletion of the first icon without deleting the second icon.

4. The image processing apparatus according to claim 3,
wherein the control unit performs deletion of the first icon and the second icon in response to an operation on the operation unit having not been performed within a predetermined time after the communication connection with the information processing apparatus has been established, and
wherein the control unit performs deletion of the second icon in response to an operation on the operation unit having not been performed within a time shorter than the predetermined time after the scan processing has been performed.

5. The image processing apparatus according to claim 1, wherein the control unit performs deletion of the first icon and the second icon in response to third processing different from the print processing and the scan processing having been performed in a state in which the communication connection with the information processing apparatus has been established.

6. A method for an image processing apparatus including a scanner and a connection unit, the method comprising:
according to a communication connection established, in response to a connection request from an information processing apparatus which lies close to the image processing apparatus, by the connection unit with the information processing apparatus, performing displaying, on an operation unit of the image processing apparatus, of a first icon operable to perform print processing for printing, by the image processing apparatus, print data received from the information processing apparatus and a second icon operable to perform scan processing for transmitting, to the information processing apparatus, scan data obtained by the scanner reading an original, and
in a case where print processing using the first icon has been performed, performing deletion of the first icon and the second icon.

7. A non-transitory computer-readable storage medium storing a computer program which, when executed by a computer, causes the computer to perform a method for an image processing apparatus including a scanner and a connection unit, the method comprising:
according to a communication connection established, in response to a connection request from an information processing apparatus which lies close to the image processing apparatus, by the connection unit with the information processing apparatus, performing displaying, on an operation unit of the image processing apparatus, of a first icon operable to perform print processing for printing, by the image processing apparatus, print data received from the information processing apparatus and a second icon operable to perform scan processing for transmitting, to the information processing apparatus, scan data obtained by the scanner reading an original, and
in a case where print processing using the first icon has been performed, performing deletion of the first icon and the second icon.
